(19) United States
(12) Patent Application Publication
(10) Pub. No.: US 2026/0038002 A1
(43) Pub. Date: Feb. 5, 2026

(54) METHOD, APPARATUS, AND ELECTRONIC DEVICE FOR GENERATING USER INTEREST FEATURES

(71) Applicant: Hangzhou Alibaba International Internet Industry Co., Ltd., Hangzhou (CN)

(72) Inventors: Lifang DENG, Beijing (CN); Jin NIU, Hangzhou (CN); Dan WANG, Beijing (CN); Jiandong ZHANG, Beijing (CN); Zhihua WU, ShenZhen (CN)

(21) Appl. No.: 19/356,799

(22) Filed: Oct. 13, 2025

Related U.S. Application Data
(63) Continuation of application No. PCT/CN2024/079456, filed on Feb. 29, 2024.

(30) Foreign Application Priority Data
May 5, 2023 (CN) 202310508748.1

(51) Int. Cl. G06Q 30/0251

(52) U.S. Cl. CPC G06Q 30/0255

(57) ABSTRACT

The present invention discloses a method for generating a user interest feature, including: obtaining behavior object feature vectors corresponding to a target time window for representing behavior objects of a user, each vector including a positive feedback object feature vector and a negative feedback object feature vector; performing an aggregation calculation on the negative feedback object feature vectors to obtain an aggregated negative feedback object vector; calculating a correlation between the aggregated negative feedback object vector and each of the positive feedback object feature vectors; and generating a preliminary interest feature representation of the user corresponding to the target time window based on the correlation, the positive feedback object feature vectors, and the aggregated negative feedback object vector. Using the above method can accurately describe the user's interest features, thereby providing a foundation for accurate recommendations.

### CROSS-REFERENCE TO RELATED APPLICATION

This application is a Continuation application of International Patent Application No. PCT/CN2024/079456, filed on Feb. 29, 2024, which is based on and claims priority to and benefits of Chinese Patent Application No. 202310508748.1, filed with the China National Intellectual Property Administration on May 5, 2023, and titled “Method, Apparatus, and Electronic Device for Generating User Interest Features.” The above-referenced applications are incorporated herein by reference in their entirety.

### TECHNICAL FIELD

The present invention relates to the field of e-commerce technology, and specifically to a method for generating a user interest feature. The present invention also relates to a method for user interest feature clustering, a user behavior prediction method, and a method for training a user behavior object prediction model. The present application also relates to an apparatus, an electronic device, and a storage medium associated with each of the aforementioned methods.

### BACKGROUND

With the development of e-commerce technology, targeted marketing is widely used on major e-commerce platforms. As a core tool in the targeted marketing model, a recommendation system can recommend products and information of interest to users when they are faced with a massive amount of product information.

During the operation of current targeted marketing models, recommendation systems have obvious defects in recommendations for the long-tail market. Specifically, a small number of head users have a high frequency of behavior on e-commerce platforms and have a large number of purchase interaction records. Therefore, a recommendation system can recommend products and information with high accuracy, strong personalization, and good applicability for them based on the large amount of behavior data of the head users. In contrast, the majority of long-tail users have a low frequency of behavior on the platform and few purchase interaction records. Therefore, the behavior data that the recommendation system can utilize is relatively sparse, and the recommendation effect for long-tail users is significantly weaker than that for head users.

To address the problem of behavior data sparsity in recommendations, a current general solution is to import auxiliary information other than user behavior into the recommendation system, such as user profiles, product text, etc., to participate in the recommendation algorithm along with user behavior data. However, this auxiliary information is not always available. For example, with increasingly strict user privacy regulations, obtaining user profiles has become more and more difficult. The extraction of product text is highly dependent on the maturity of NLP (Natural Language Processing) technology, and NLP technology still faces many challenges when dealing with texts in less common languages.

Therefore, for the vast number of long-tail users on e-commerce platforms, how to improve the accuracy of product recommendations and user click-through rate prediction in the absence of auxiliary information has become an urgent problem to be solved.

### SUMMARY

To overcome the deficiencies of the prior art, one of the objectives of the present invention is to provide a method for generating a user interest feature, in order to accurately describe a user's interest features, thereby providing a foundation for more accurate recommendations.

Another objective of the present invention is to provide a method for user interest feature clustering, which uses the interest features obtained by the aforementioned method and achieves accurate clustering of user interest features, making more accurate recommendations possible.

A further objective of the present invention is to provide a user behavior prediction method, which uses the above clustering results of user interest features and the obtained user interest features to predict, for a target user, the probability of a behavior towards a specific recommended object.

A first aspect of the present application provides a method for generating a user interest feature, including: obtaining behavior object feature vectors corresponding to a target time window and configured to represent behavior objects of a user; each of the behavior object feature vectors configured to represent a behavior object of the user including a positive feedback object feature vector and a negative feedback object feature vector; performing an aggregation calculation on the negative feedback object feature vectors to obtain an aggregated negative feedback object vector corresponding to the negative feedback object feature vectors; calculating a correlation between the aggregated negative feedback object vector and each of the positive feedback object feature vectors; and generating a preliminary interest feature representation of the user corresponding to the target time window based on the correlation, the positive feedback object feature vectors, and the aggregated negative feedback object vector.

Optionally, the obtaining the behavior object feature vectors corresponding to the target time window and configured to represent the behavior objects of the user includes: obtaining a user behavior sequence sample; performing a grouping process on the user behavior sequence sample corresponding to a preset time window to obtain a user behavior group sample corresponding to each time window; for each of the user behavior group samples, obtaining behavior objects corresponding to user behaviors therein; and within a selected target time window, generating the behavior object feature vectors corresponding to the target time window based on the behavior objects corresponding to the user behaviors.

Optionally, the generating the behavior object feature vectors corresponding to the target time window based on the behavior objects corresponding to the user behaviors within the selected target time window includes: filtering the behavior objects of the user in the selected target time window according to a preset filtering condition to obtain sample behavior objects; and generating the behavior object feature vectors corresponding to the target time window based on the sample behavior objects.

Optionally, the preset filtering condition includes one or more of the following factors: a frequency of the user's behavior towards a behavior object reaches a preset value, a time duration of the user's behavior towards a behavior object reaches a preset value, or a type of the user's behavior towards a behavior object conforms to a preset type.

Optionally, the generating the preliminary interest feature representation of the user corresponding to the target time window based on the correlation, the positive feedback object feature vectors, and the aggregated negative feedback object vector includes: obtaining a correlation index of each the positive feedback object feature vector with the aggregated negative feedback object vector; using the positive feedback object feature vectors whose correlation index is lower than a preset correlation threshold as available positive feedback object feature vectors; and generating the preliminary interest feature representation of the user based on the correlation, the available positive feedback object feature vectors, and the aggregated negative feedback object vector.

Optionally, the generating the preliminary interest feature representation of the user based on the correlation, the available positive feedback object feature vectors, and the aggregated negative feedback object vector includes: assigning a second weight to each of the available positive feedback object feature vectors in a preset manner based on the correlation of the available positive feedback object feature vectors with the aggregated negative feedback object vector, wherein the higher the correlation, the lower the weight; and generating the preliminary interest feature representation of the user using the aggregated negative feedback object vector and the weighted positive feedback object feature vectors.

Optionally, the generating the preliminary interest feature representation of the user using the aggregated negative feedback object vector and the weighted positive feedback object feature vectors includes: inputting each of the weighted positive feedback object feature vectors into a first transformer neural network to obtain an aggregated positive feedback object vector; and fusing the aggregated positive feedback object vector and the aggregated negative feedback object vector to obtain the preliminary interest feature representation of the user.

Optionally, before the step of generating the preliminary interest feature representation of the user corresponding to the target time window based on the correlation, the positive feedback object feature vectors, and the aggregated negative feedback object vector, the method includes the following step: assigning a first weight to a corresponding the positive feedback object feature vector based on a frequency of each the positive feedback object as a user behavior object; wherein in the step of generating the preliminary interest feature representation of the user corresponding to the target time window based on the correlation, the positive feedback object feature vectors, and the aggregated negative feedback object vector, the positive feedback object feature vectors assigned with the first weight are used.

Optionally, fusing the aggregated positive feedback object vector and the aggregated negative feedback object vector is performed by concatenation.

A second aspect of the present application provides a method for user interest feature clustering, the method including: obtaining a preliminary interest feature representation and an interest category feature representation of a target user; the interest category feature representation being a feature representation for each interest category formed by classifying users into types based on user interest; performing a mapping and fusion process on the preliminary interest feature representation of the target user based on the interest category feature representation to obtain an interest feature representation encoding of the target user; performing a decoding processing on the interest feature representation encoding of the target user to obtain a decoded interest feature representation encoding; calculating a loss value between the decoded interest feature representation encoding and a preset target interest feature representation, and adjusting the encoder model, the decoder model, and the interest category feature representation based on the loss value until the loss value reaches a predetermined target; and obtaining an interest category representation to which the target user belongs in the target time window based on a dimension-reduced feature representation at this time.

Optionally, the target interest feature representation uses the preliminary interest feature representation of the user, or uses a high-level interest feature representation; the high-level interest feature representation is obtained after performing an association process on the preliminary interest feature representation of the target time window and preliminary interest feature representations of other time windows.

A third aspect of the present application provides a user behavior object prediction method, including: obtaining user behavior samples divided by time windows; generating behavior object feature vectors configured to represent behavior objects of a user based on the user behavior samples; each of the behavior object feature vectors configured to represent a behavior object of the user including a positive feedback object feature vector and a negative feedback object feature vector; generating a preliminary interest feature representation of the user corresponding to each time window based on the behavior object feature vectors; performing an interaction processing on the preliminary interest feature representation of each time window with preliminary interest feature representations of other time windows to obtain a high-level interest feature representation for each time window; using the preliminary interest feature representation and the high-level interest feature representation of each time window, and an interest category feature representation for each interest category formed by classifying users into types based on user interest, to obtain a time window interest category representation to which a target user belongs for each time window; fusing the time window interest category representation to which the target user belongs for each time window and the high-level interest feature representation of the user corresponding to each time window to obtain a target interest category feature representation of the target user; and estimating a behavior probability of the target user towards a target behavior object using the target interest category representation of the target user.

Optionally, the generating the preliminary interest feature representation of the user corresponding to each time window based on the behavior object feature vectors, wherein a process of generating the preliminary interest feature representation corresponding to a target time window includes: obtaining behavior object feature vectors corresponding to the target time window and configured to represent behavior objects of the user; each of the behavior object feature vectors configured to represent a behavior object of the user including a positive feedback object feature vector and a negative feedback object feature vector; performing an aggregation calculation on the negative feedback object feature vectors to obtain an aggregated negative feedback object vector corresponding to the negative feedback object feature vectors; calculating a correlation between the aggregated negative feedback object vector and each of the positive feedback object feature vectors; and generating the preliminary interest feature representation of the user corresponding to the target time window based on the correlation, the positive feedback object feature vectors, and the aggregated negative feedback object vector.

Optionally, the using the preliminary interest feature representation and the high-level interest feature representation of each time window, and the interest category feature representation for each interest category formed by classifying users into types based on user interest, to obtain the time window interest category representation to which the target user belongs for each time window, includes: obtaining a preliminary interest feature representation and an interest category feature representation of the target user in a target time window; performing a mapping and fusion process on the preliminary interest feature representation of the target user based on the interest category feature representation to obtain an interest feature representation encoding of the target user; performing a decoding processing on the interest feature representation encoding of the target user to obtain a decoded interest feature representation encoding; calculating a loss value between the decoded interest feature representation encoding and the high-level interest feature representation of the user in the target time window, and adjusting the encoder model, the decoder model, and the interest category feature representation based on the loss value until the loss value reaches a predetermined target; and obtaining the interest category representation to which the target user belongs in the target time window based on a dimension-reduced feature representation at this time.

Optionally, the estimating the behavior probability of the target user towards the target behavior object using the target interest category representation of the target user includes: performing an attention mechanism processing on the target interest category representation of the target user and a target behavior object feature representation to obtain an attention mechanism representation of the target user; and providing the attention mechanism representation of the target user and the target behavior object feature representation to a pre-trained machine learning model to obtain the behavior probability of the target user towards the target behavior object.

A fourth aspect of the present application provides a method for training a user behavior object prediction model, including: obtaining user behavior samples divided by time windows, wherein the samples include behavior objects associated with user behaviors; for each time window, generating, in an input layer of an existing model, behavior object feature vectors configured to represent behavior objects of a user; each of the behavior object feature vectors configured to represent a behavior object of the user including a positive feedback object feature vector and a negative feedback object feature vector; generating, in a user interest extraction model, a preliminary interest feature representation of the user corresponding to each time window based on the behavior object feature vectors; performing an interaction processing on the preliminary interest feature representation of each time window with preliminary interest feature representations of other time windows through a transformer neural network to obtain a high-level interest feature representation corresponding to each time window; using the preliminary interest feature representation and the high-level interest feature representation of each time window, and an interest category feature representation for each interest category formed by classifying users into types based on user interest, to obtain, in a user interest clustering model, a time window interest category representation to which a target user belongs for each time window; fusing the time window interest category representation to which the target user belongs for each time window and the high-level interest feature representation of the user corresponding to each time window to obtain a target interest category feature representation of the target user; estimating, using the target interest category representation of the target user, a result of an estimation of a behavior probability of the target user towards each behavior object involved in the user behavior sample; and comparing the estimation result with an actual record of the user's behavior towards the behavior object in the user behavior sample, and adjusting parameters of each model involved in the user behavior object prediction model based on a comparison result until a predetermined standard is reached.

A fifth aspect of the present application provides a method for generating a user interest feature, applied to a cloud server, the method including: obtaining an interest feature request message sent from a client device for requesting to obtain a user interest feature; in response to the interest feature request message, returning page content associated with the user interest feature to the client device; wherein the page content associated with the user interest feature is obtained based on an estimated behavior probability of a target user towards a target behavior object; the estimated behavior probability of the target user towards the target behavior object is obtained as follows: obtaining user behavior samples divided by time windows; generating behavior object feature vectors configured to represent behavior objects of a user based on the user behavior samples; each of the behavior object feature vectors configured to represent a behavior object of the user including a positive feedback object feature vector and a negative feedback object feature vector; generating a preliminary interest feature representation of the user corresponding to each time window based on the behavior object feature vectors; performing an interaction processing on the preliminary interest feature representation of each time window with preliminary interest feature representations of other time windows to obtain a high-level interest feature representation for each time window; using the preliminary interest feature representation and the high-level interest feature representation of each time window, and an interest category feature representation for each interest category formed by classifying users into types based on user interest, to obtain a time window interest category representation to which the target user belongs for each time window; fusing the time window interest category representation to which the target user belongs for each time window and the high-level interest feature representation of the user corresponding to each time window to obtain a target interest category feature representation of the target user; and estimating the behavior probability of the target user towards the target behavior object using the target interest category representation of the target user.

A sixth aspect of the present application provides a method for generating a user interest feature, applied to a client device, the method including: sending an interest feature request message to a cloud server for requesting to obtain a user interest feature; receiving page content associated with the user interest feature returned by the cloud server; in response to detecting a trigger operation by a target user on preset page content, displaying the page content associated with the user interest feature; or, in response to detecting a trigger operation by the target user on a query object, displaying the page content associated with the user interest feature; wherein the page content associated with the user interest feature is obtained based on an estimated behavior probability of the target user towards a target behavior object, which is estimated by the cloud server according to the method provided in the fifth aspect above.

A seventh aspect of the present application provides an apparatus for generating a user interest feature, including: an obtaining unit, configured to obtain behavior object feature vectors corresponding to a target time window and configured to represent behavior objects of a user; each of the behavior object feature vectors configured to represent a behavior object of the user including a positive feedback object feature vector and a negative feedback object feature vector; a processing unit, configured to perform an aggregation calculation on the negative feedback object feature vectors to obtain an aggregated negative feedback object vector corresponding to the negative feedback object feature vectors; a calculation unit, configured to calculate a correlation between the aggregated negative feedback object vector and each of the positive feedback object feature vectors; and an interest feature representation generation unit, configured to generate a preliminary interest feature representation of the user corresponding to the target time window based on the correlation, the positive feedback object feature vectors, and the aggregated negative feedback object vector.

An eighth aspect of the present application provides an apparatus for user interest feature clustering, including: an obtaining unit, configured to obtain a preliminary interest feature representation and an interest category feature representation of a target user; the interest category feature representation being a feature representation for each interest category formed by classifying users into types based on user interest; a processing unit, configured to perform a mapping and fusion process on the preliminary interest feature representation of the target user based on the interest category feature representation to obtain an interest feature representation encoding of the target user; a construction unit, configured to perform a decoding processing on the interest feature representation encoding of the target user to obtain a decoded interest feature representation encoding; and a calculation unit, configured to calculate a loss value between the decoded interest feature representation encoding and a preset target interest feature representation, and adjust the encoder model, the decoder model, and the interest category feature representation based on the loss value until the loss value reaches a predetermined target; and obtain an interest category representation to which the target user belongs in the target time window based on a dimension-reduced feature representation at this time.

A ninth aspect of the present application provides an apparatus for user behavior object prediction, including: an obtaining unit, configured to obtain user behavior samples divided by time windows; a first processing unit, configured to generate behavior object feature vectors configured to represent behavior objects of a user based on the user behavior samples; each of the behavior object feature vectors configured to represent a behavior object of the user including a positive feedback object feature vector and a negative feedback object feature vector; a second processing unit, configured to generate a preliminary interest feature representation of the user corresponding to each time window based on the behavior object feature vectors; a feature representation obtaining unit, configured to perform an interaction processing on the preliminary interest feature representation of each time window with preliminary interest feature representations of other time windows to obtain a high-level interest feature representation for each time window; an interest category classification unit, configured to use the preliminary interest feature representation and the high-level interest feature representation of each time window, and an interest category feature representation for each interest category formed by classifying users into types based on user interest, to obtain a time window interest category representation to which a target user belongs for each time window; a fusion processing unit, configured to fuse the time window interest category representation to which the target user belongs for each time window and the high-level interest feature representation of the user corresponding to each time window to obtain a target interest category feature representation of the target user; and a behavior probability obtaining unit, configured to estimate a behavior probability of the target user towards a target behavior object using the target interest category representation of the target user.

A tenth aspect of the present application provides an apparatus for training a user behavior object prediction model, including: an obtaining unit, configured to obtain user behavior samples divided by time windows, wherein the samples include behavior objects associated with user behaviors; a first processing unit, configured to, for each time window, generate, in an input layer of an existing model, behavior object feature vectors configured to represent behavior objects of a user; each of the behavior object feature vectors configured to represent a behavior object of the user including a positive feedback object feature vector and a negative feedback object feature vector; a feature representation generation unit, configured to generate, in a user interest extraction model, a preliminary interest feature representation of the user corresponding to each time window based on the behavior object feature vectors; an interaction processing unit, configured to perform an interaction processing on the preliminary interest feature representation of each time window with preliminary interest feature representations of other time windows through a transformer neural network to obtain a high-level interest feature representation corresponding to each time window; a category representation obtaining unit, configured to use the preliminary interest feature representation and the high-level interest feature representation of each time window, and an interest category feature representation for each interest category formed by classifying users into types based on user interest, to obtain, in a user interest clustering model, a time window interest category representation to which a target user belongs for each time window; a fusion processing unit, configured to fuse the time window interest category representation to which the target user belongs for each time window and the high-level interest feature representation of the user corresponding to each time window to obtain a target interest category feature representation of the target user; a behavior probability estimation unit, configured to estimate, using the target interest category representation of the target user, a result of an estimation of a behavior probability of the target user towards each behavior object involved in the user behavior sample; and a parameter adjustment unit, configured to compare the estimation result with an actual record of the user's behavior towards the behavior object in the user behavior sample, and adjust parameters of each model involved in the user behavior object prediction model based on a comparison result until a predetermined standard is reached.

An eleventh aspect of the present application provides an apparatus for generating a user interest feature, applied to a cloud server, including: an obtaining unit, configured to obtain an interest feature request message sent from a client device for requesting to obtain a user interest feature; a transmission unit, configured to, in response to the interest feature request message, return page content associated with the user interest feature to the client device; wherein the page content associated with the user interest feature is obtained based on an estimated behavior probability of a target user towards a target behavior object; the estimated behavior probability of the target user towards the target behavior object is obtained as follows: obtaining user behavior samples divided by time windows; generating behavior object feature vectors configured to represent behavior objects of a user based on the user behavior samples; each of the behavior object feature vectors configured to represent a behavior object of the user including a positive feedback object feature vector and a negative feedback object feature vector; generating a preliminary interest feature representation of the user corresponding to each time window based on the behavior object feature vectors; performing an interaction processing on the preliminary interest feature representation of each time window with preliminary interest feature representations of other time windows to obtain a high-level interest feature representation for each time window; using the preliminary interest feature representation and the high-level interest feature representation of each time window, and an interest category feature representation for each interest category formed by classifying users into types based on user interest, to obtain a time window interest category representation to which the target user belongs for each time window; fusing the time window interest category representation to which the target user belongs for each time window and the high-level interest feature representation of the user corresponding to each time window to obtain a target interest category feature representation of the target user; and estimating the behavior probability of the target user towards the target behavior object using the target interest category representation of the target user.

A twelfth aspect of the present application provides an apparatus for generating a user interest feature, applied to a client device, including: a sending unit, configured to send an interest feature request message to a cloud server for requesting to obtain a user interest feature; a receiving unit, configured to receive page content associated with the user interest feature returned by the cloud server; a first processing unit, configured to, in response to detecting a trigger operation by a target user on preset page content, display the page content associated with the user interest feature; or, in response to detecting a trigger operation by the target user on a query object, display the page content associated with the user interest feature; wherein the page content associated with the user interest feature is obtained based on an estimated behavior probability of the target user towards a target behavior object, which is estimated by the apparatus provided in the eleventh aspect above.

A thirteenth aspect of the present application provides an electronic device, including a processor and a memory; wherein the memory is configured to store one or more computer instructions, and wherein the one or more computer instructions are executed by the processor to implement the method of any one of the preceding embodiments.

A fourteenth aspect of the present application provides a computer-readable storage medium, on which one or more computer instructions are stored, wherein the instructions are executed by a processor to implement the method of any one of the preceding embodiments.

The method for generating a user interest feature provided by the present application includes: obtaining behavior object feature vectors corresponding to a target time window and configured to represent behavior objects of a user; each of the behavior object feature vectors configured to represent a behavior object of the user including a positive feedback object feature vector and a negative feedback object feature vector; performing an aggregation calculation on the negative feedback object feature vectors to obtain an aggregated negative feedback object vector corresponding to the negative feedback object feature vectors; calculating a correlation between the aggregated negative feedback object vector and each of the positive feedback object feature vectors; and generating a preliminary interest feature representation of the user corresponding to the target time window based on the correlation, the positive feedback object feature vectors, and the aggregated negative feedback object vector. The preliminary interest feature representation provided by the above method can reflect the interest features of the target user in the target time window, thereby providing initial data for the subsequent evaluation of the probability of the user's behavior (such as a click) towards a behavior object, such as a product.

In the user behavior object prediction method further provided by the present application, the preliminary user interest features obtained in the foregoing steps, the high-level user interest features further obtained through the preliminary user interest features, and the user interest category representation obtained through user clustering are used to perform a fusion process on this information to deduce a target interest category representation of the user, and the target interest category representation of the target user is used to estimate the behavior probability of the target user towards a target behavior object. Since this method uses the target interest category of the target user as the basis for deducing their behavior, it can utilize the behavior data of other similar customers, which can effectively solve the problem of accurately recommending to long-tail users and avoid the problem of being unable to make accurate recommendations due to overly sparse user data.

In the user behavior object prediction method further provided by the present application, the preliminary user interest features obtained in the foregoing steps, the high-level user interest features further obtained through the preliminary user interest features, and the user interest category representation obtained through user clustering are used to perform a fusion process on this information to deduce a target interest category representation of the user, and the target interest category representation of the target user is used to estimate the behavior probability of the target user towards a target behavior object. Since this method uses the target interest category of the target user as the basis for deducing their behavior, it can utilize the behavior data of other similar customers, which can effectively solve the problem of accurately recommending to long-tail users and avoid the problem of being unable to make accurate recommendations due to overly sparse user data.

The present application also provides a method for training a user behavior object prediction model, which can be used to achieve end-to-end model training.

### BRIEF DESCRIPTION OF THE DRAWINGS

To more clearly explain the technical solutions in the embodiments of the present application or in the prior art, the drawings required for the description of the embodiments or the prior art will be briefly introduced below. It is obvious that the drawings in the following description are only some embodiments described in the present application, and for those of ordinary skill in the art, other drawings can be obtained based on these drawings.

FIG. 1 is a schematic diagram of an application scenario of a method for generating a user interest feature in an embodiment of the present application;

FIG. 2 is a schematic flowchart of a first embodiment of the present application;

FIG. 3 is a schematic diagram of a user behavior sequence sample corresponding to the first embodiment of the present application;

FIG. 4 is a UBP model architecture diagram corresponding to the first embodiment of the present application;

FIG. 5 is a flowchart of generating a first interest feature representation of a user corresponding to the first embodiment of the present application;

FIG. 6 is a flowchart of a method for user interest feature clustering in a second embodiment of the present application;

FIG. 7 is a UBC model architecture diagram corresponding to the second embodiment of the present application;

FIG. 8 is a flowchart of a user behavior object prediction method in a third embodiment of the present application;

FIG. 9 is an HIM model architecture diagram corresponding to the third embodiment of the present application;

FIG. 10 is a schematic diagram of feature vector transformation in the HIM model of the third embodiment of the present application;

FIG. 11 is a flowchart of a method for training a user behavior object prediction model in a fourth embodiment of the present application;

FIG. 12 is a flowchart of a method for generating a user interest feature in a fifth embodiment of the present application;

FIG. 13 is a flowchart of a method for generating a user interest feature in a sixth embodiment of the present application;

FIG. 14 is a schematic structural diagram of an apparatus for generating a user interest feature in a seventh embodiment of the present application;

FIG. 15 is a schematic structural diagram of an apparatus for user interest feature clustering in an eighth embodiment of the present application;

FIG. 16 is a schematic structural diagram of an apparatus for user behavior object prediction in a ninth embodiment of the present application;

FIG. 17 is a schematic structural diagram of an apparatus for training a user behavior object prediction model in a tenth embodiment of the present application;

FIG. 18 is a schematic structural diagram of an apparatus for generating a user interest feature in an eleventh embodiment of the present application;

FIG. 19 is a schematic structural diagram of an apparatus for generating a user interest feature in a twelfth embodiment of the present application;

FIG. 20 is a schematic logical structure diagram of an electronic device provided in a thirteenth embodiment of the present application.

### DETAIL DESCRIPTION OF THE EMBODIMENTS

To make the objectives, advantages, and features of the present application clearer, a method for generating a user interest feature, a method for user interest feature clustering, and a user behavior object prediction method proposed in the present application will be further described in detail below in conjunction with the accompanying drawings and specific embodiments. Many specific details are set forth in the following description to facilitate a full understanding of the present invention. However, the present invention can be implemented in many other ways different from those described herein, and a person skilled in the art can make similar extensions without departing from the spirit of the present invention. Therefore, the present invention is not limited by the specific embodiments disclosed below.

It should be noted that in the description of the present application, terms such as “first” and “second” are used for descriptive purposes only and cannot be understood as indicating or implying relative importance, or a specific order or sequence. For a person of ordinary skill in the art, the specific meanings of the above terms in the present application can be understood according to the specific situation. In addition, in the description of the present application, unless otherwise specified, the term “a plurality of” refers to two or more. The term “and/or” describes the association relationship of associated objects, indicating that three relationships can exist. For example, A and/or B can mean: A exists alone, A and B exist at the same time, and B exists alone. The character “/” generally indicates that the associated objects before and after it have an “or” relationship. The terms “including” and “having” and any variations thereof are intended to cover non-exclusive inclusions. For example, a process, method, system, product, or device that includes a series of steps or units is not necessarily limited to those clearly listed steps or units, but may include other steps or units not clearly listed or inherent to these processes, methods, products, or devices.

First, the nouns and terms involved in one or more embodiments of the present application are explained.

Click-through Ratio (CTR) of a product refers to the probability that a user clicks to view the details of a product when it is displayed to the user. Its calculation method is: Click-through Rate=Clicks/Impressions, where impressions refer to the number of times a product is displayed to a user, and clicks refer to the number of times a product is clicked and viewed by a user. The recommendation effect in a product recommendation system is measured by the estimated click-through rate of products. Based on the estimated product click-through rate, the products to be recommended to the user are determined and displayed in a sorted manner. By predicting the click-through rate of products in a candidate set for a user, it is decided which product to display to the user. In the present application, considering that other objects displayed on the network platform may also become click objects for the user, and further considering that clicking is not the only way for a user to interact with the objects displayed on the network platform, the “click” mentioned in the above explanation is generalized as “behavior,” and “product” is generalized as “behavior object.” In the following description of specific embodiments, “click” or “behavior,” and “product” or “behavior object” will be selected according to the situation.

UBP model: User Behavior Pyramid (UBP) model, also known as the preliminary interest feature representation acquisition model. Based on its principle, it is a personalized interest extraction module based on confidence modeling of positive feedback behavior objects and negative feedback behavior objects, used to obtain a user's personalized interest representation. The UBP model is a model specially provided by the present application according to the use scenario to obtain a user's preliminary interest feature representation, and it specifically executes the method for generating a user interest feature provided in the first embodiment of the present application.

UBC model: User Behavior Clustering (UBC) model, also known as the interest group feature representation acquisition model, is a user interest clustering module based on semi-supervised learning, used to obtain a user's semi-personalized interest representation. The final output result is to obtain the interest group representation of a target user, that is, to know which interest group the target user belongs to, and to give the mathematical expression of that interest group, which is generally represented by a feature vector corresponding to each interest group, referred to herein as the target user's interest group representation. This model is used to execute the method for user interest feature clustering provided in the second embodiment of the present application.

HIM model: Hierarchical Interest Modeling (HIM) model, also known as the user behavior object prediction model, is a hierarchical interest modeling model based on the characteristics of users with few behaviors. Using this model, the probability of a user's behavior towards a target behavior object can be obtained based on the user's historical behavior data; in other words, the probability of a user clicking on a specific product can be obtained. The aforementioned UBP model and UBC model are used in this model.

Next, to facilitate understanding of the embodiments of the present application, the application background of the embodiments will be explained.

The number and variety of products on major e-commerce platforms are growing rapidly, and users need to spend a lot of time and energy searching for the products they want to buy when faced with a massive amount of product information. The targeted marketing model has become a favorite of various e-commerce platforms because it can recommend products and information of interest to users. The recommendation system, as the core technical tool in the targeted marketing model, has become a research focus.

The traditional market curve conforms to the 80/20 rule (80% of sales come from 20% of popular brand products). However, when applied to e-commerce platforms on the Internet, this rule has been challenged. E-commerce platforms allow 99% of products to have the opportunity to be sold to users. Under normal circumstances, popular products meet the needs of most users, while non-popular products can also represent the needs of small groups of users. Due to the large number of non-popular products on e-commerce platforms, to fully develop the market sales of non-popular products, it is necessary to fully study the personalized needs of users and to be able to accurately recommend both popular and non-popular products to users with needs. Currently, there is a significant long-tail phenomenon in the targeted marketing model recommendation systems of major e-commerce platforms. Here, the long-tail phenomenon is explained. The long-tail phenomenon refers to the fact that a small number of head users, who account for a minority of users, perform a large number of effective operations. These head users have a high frequency of behavior and rich purchase interaction record data on the platform, and the recommendation system can recommend products with high accuracy, strong personalization, and good applicability for them based on the interaction data of the head users. However, most users are long-tail users in the long-tail phenomenon. Their user base is large, but their behavior frequency on the platform is low, the time interval between behaviors is long, and their purchase interaction record data is scarce, resulting in a significantly weaker recommendation effect for the products recommended by the recommendation system compared to the recommendation effect for head users.

Therefore, for long-tail users on e-commerce platforms who have a low frequency of platform behavior, long intervals between behaviors, and scarce purchase interaction record data, there is a need to improve personalized, accurate, and applicable electronic product recommendation services, thereby increasing the platform stickiness for this type of user and reducing the user churn rate.

The present application provides a method for generating a user interest feature, a method for user interest feature clustering, a user behavior object prediction method, a method for training a user behavior object prediction model, and related apparatus, electronic device, and storage medium, aiming to provide a method that can provide accurate product recommendations for long-tail users. Naturally, the method of the present application can also be applied to other occasions in the Internet field that require object recommendation. The present application does not limit the specific application field. For the convenience of description, the following uses the recommendation of suitable products to users on an e-commerce platform as a typical application scenario and explains the above-mentioned methods provided by the present application around this scenario.

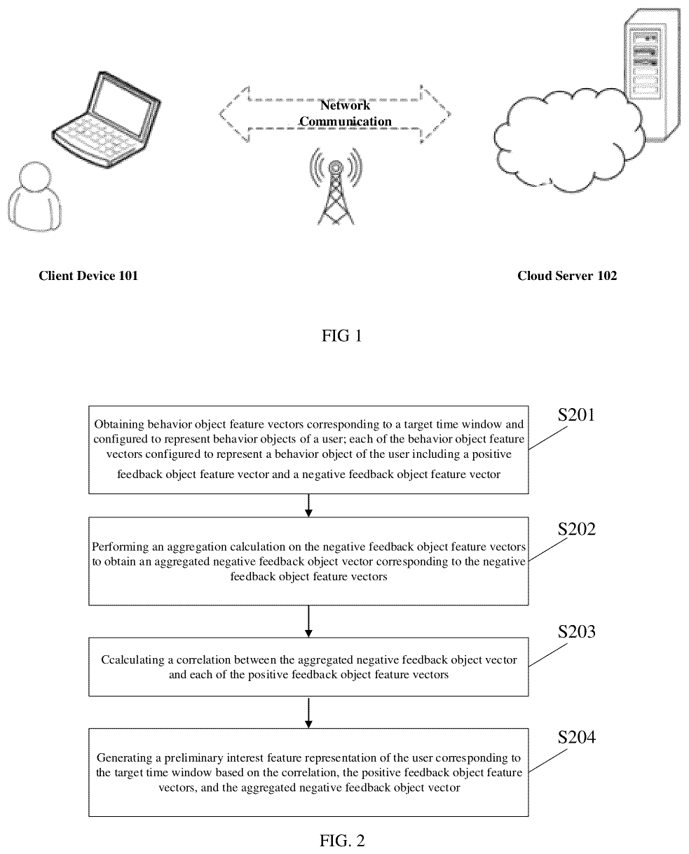

To facilitate understanding of the method embodiments of the present application, their application scenarios are introduced. Please refer to FIG. 1, which is a schematic diagram of an application scenario of a method embodiment of the present application. It can be applied to a cloud server. This application scenario is an illustrative example and does not serve as a specific description to limit its application scenarios.

As shown in FIG. 1, a client device 101 and a cloud server 102 are provided in this application scenario. In this embodiment, the client device 101 and the cloud server 102 are directly connected through network communication.

The client device 101 can also be called a user terminal, corresponding to the cloud server 102, and accepts the control and management of the cloud server 102. In the implementation of this embodiment, the client device 101 can be understood as a client device running a specific application, such as a mobile phone, a tablet computer (pad), or more specifically, an application (APP) used to provide local services to users. The specific client device 101 can include various smart terminal devices connected to the Internet, and their number is huge. The client device 101 and the cloud server 102 are usually directly connected via the Internet, thereby providing the computing and storage capabilities of the cloud server 102 to the user of the client device 101. In this embodiment, the client device 101 is mainly used to obtain user behavior data, such as click behavior data, browsing behavior data, add-to-cart behavior data, etc. Since user behavior data can be processed and converted into user behavior samples, and there is a correlation between user behavior samples and behavior objects, it is possible to analyze and obtain the interest feature representation of this user by collecting the user's behavior data, such as obtaining the products the user is interested in and not interested in.

The cloud server 102 includes cloud servers, which can be realized by virtualizing many physical servers, and its computing and storage capabilities can be expanded as needed at any time. The cloud server 102 is deployed with models for user interest feature mining. In the embodiments of the present application, these include the UBP model, the UBC model, and the HIM model. Specifically for the e-commerce platform application scenario, the cloud server 102 is also deployed with an e-commerce platform. Through the e-commerce platform provided by the cloud server 102, user behavior data transmitted from the client device 101 can be received and processed into samples on the cloud server 102 to form user behavior samples. These user behavior samples are provided to the above models for analysis and processing, and the interest features of the user corresponding to the client device 101 can be obtained.

In the embodiments of the present application, the cloud server 102 can be separately configured with the UBP model, the UBC model, and the HIM model. The cloud server 102 can also comprehensively configure the above three models, and the configuration method can be adjusted according to specific practical needs. This embodiment does not make specific limitations on this. The specific physical devices used by the servers of the cloud server and the communication relationships between these devices can be handled by the manufacturer providing cloud computing services. The cloud server 102 includes a highly scalable server cluster that virtualizes physical servers. For the user, there is no need to care about the specific hardware implementation of the cloud server 102.

Based on this, the method embodiments provided by the present application are introduced below. Please refer to FIG. 2, which is a schematic flowchart of the first embodiment of the present application. This method embodiment is applied to the preliminary interest feature representation acquisition model (UBP model). The method is specifically described below in conjunction with FIG. 2.

S201, obtaining behavior object feature vectors corresponding to a target time window and configured to represent behavior objects of a user; each behavior object feature vector configured to represent a behavior object of the user including a positive feedback object feature vector and a negative feedback object feature vector.

This step is for obtaining the user's behavior object feature vectors.

A time window is a requirement of the preliminary interest feature representation acquisition model (UBP model), which is a continuous time period dynamically preset based on time parameters for dividing a user behavior sequence sample. Since user behavior is based on a timeline and the sequence of behavior occurrences shows a multi-peak expression, the time window set by the UBP model is a dynamic window. The setting of the above time window can be adjusted accordingly based on the specific behavior sequence sample of the user. Under normal circumstances, one or more time windows will be set based on the specific behavior sequence sample of the user. Therefore, the target time window is one of the many divided time windows, and obtaining the behavior object feature vectors corresponding to the target time window and configured to represent the behavior objects of the user is to obtain the positive feedback object feature vectors and the negative feedback object feature vectors of a certain user in a time window. Furthermore, the behavior object feature vectors corresponding to the target time window and configured to represent the behavior objects of the user is a comprehensive feature vector representation of all behavior objects in that time window. In other words, the behavior object feature vectors in the above target time window are vectors respectively corresponding to multiple behavior objects in that target time window.

For example, if user A's multiple shopping behaviors in their shopping account over the past year are concentrated in December, then based on user A's shopping behavior sequence sample for the whole year, the time windows for this year can be dynamically set for user A, with multiple time windows set at high density in December and sparsely set in other months.

Furthermore, the time window corresponding to December 1st is selected as the target time window, and the positive feedback object feature vectors and the negative feedback object feature vectors for representing user A's behavior objects in the target time window of December 1st are obtained. The above positive feedback object feature vectors are a comprehensive vector representation of all positive feedback objects in the target time window of December 1st, and the negative feedback object feature vectors are a comprehensive vector representation of all negative feedback objects in the target time window of December 1st. Illustratively, all positive feedback products in the target time window of December 1st are respectively formed into positive feedback object feature vectors.

The user is a user of an application. In this embodiment, the user can be a user in many types of applications such as shopping, office, gaming, entertainment, etc. The relevant behaviors that occur when the user is in the application are called user behaviors. For example, purchase behavior, click behavior, non-click behavior, browsing behavior, add-to-cart behavior, collection behavior, etc. For ease of understanding, the embodiments of the present application all use users in shopping applications as examples for illustration.

The user's behavior object refers to an object that can be displayed to the user on the client side corresponding to the application. For example, all the products displayed on the screen of user A's shopping APP. It should be understood that when user A is using the shopping APP, there can be a corresponding user behavior for all the displayed products. For example, user A sees product X but is not interested and thus ignores product X. The above ignore behavior can also be considered as user A's user behavior in this embodiment, and the behavior object of this ignore behavior is product X.

Furthermore, the user behaviors can be divided into positive feedback behaviors and negative feedback behaviors. A positive feedback behavior refers to the behavior that occurs when the user is interested in a behavior object; a negative feedback behavior refers to the behavior that occurs when the user is not interested in a behavior object. That is, any behavior that can reflect the user's interest in a behavior object can be considered a positive feedback behavior; any behavior that can reflect the user's lack of interest in a behavior object can be considered a negative feedback behavior. For example, the ignore behavior mentioned earlier is a negative feedback behavior of user A; a click-and-add-to-cart behavior can be considered a user's positive feedback behavior. Since there are many types of user behaviors, this is an illustrative example, and a person skilled in the art can easily understand the difference between the above positive feedback behavior and negative feedback behavior.

There is a correlation between user behavior and behavior objects. In other words, user behavior corresponds to a behavior object, and by obtaining the user behavior, the behavior object corresponding to that behavior can be obtained. In this embodiment, it specifically refers to obtaining the user's behavior object and user behavior based on user behavior samples. Among them, the behavior object determined based on the positive feedback behavior and the correlation is the positive feedback object; the behavior object determined based on the negative feedback behavior and the correlation is the negative feedback object.

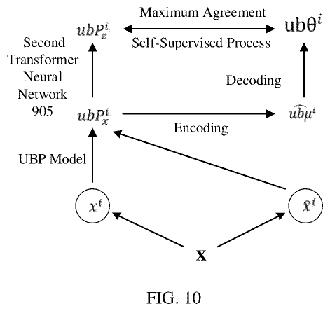

In this embodiment, the positive feedback object feature vector is obtained based on the positive feedback object; the negative feedback object feature vector is obtained based on the negative feedback object. The positive feedback object feature vector and the negative feedback object feature vector are both abstract feature representations in a high-dimensional space, and the behavior object feature vector can be used to represent the abstract features corresponding to the behavior object. In this embodiment, the server on the server side can process the user behavior data transmitted by the client into samples to obtain user behavior samples. Based on the analysis of the user behavior samples, the positive feedback object feature vectors and the negative feedback object feature vectors corresponding to the above user behavior data are obtained. Furthermore, the positive feedback behavior feature vectors and the negative feedback behavior feature vectors can also be analyzed and obtained from the above user behavior samples. In a specific implementation, referring to the illustration in FIG. 10, the above user behavior sample can be represented by the symbol “x”. After analysis and processing by the server, the behavior object feature vector “χⁱ” and the behavior feature vector “\hat{x}ⁱ” corresponding to the user behavior sample “x” can be obtained. Since the behavior feature vector “\hat{x}ⁱ” is not a research focus in the embodiments of the present application, it will not be described in detail. The above behavior object feature vector includes a positive feedback object feature vector and a negative feedback object feature vector.

For ease of understanding, in this embodiment, the positive feedback object feature vector and the negative feedback object feature vector are illustrated as examples. For example, as shown in FIG. 4, the abstract identifier for the positive feedback object feature vector is “ [symbol] ”; the abstract identifier for the positive feedback object feature vector is “ [symbol] ”. For a more detailed process of obtaining the behavior object corresponding to user behavior, the behavior object feature vector, and obtaining the positive feedback object feature vector and the negative feedback object feature vector, please refer to the subsequent description.

The obtaining the behavior object feature vector corresponding to the target time window and configured to represent the behavior object of the user includes:
Step S201-1, obtaining a user behavior sequence sample;
Step S201-2, performing a grouping process on the user behavior sequence sample corresponding to a preset time window to obtain a user behavior group sample corresponding to each time window;
Step S201-3, for each the user behavior group sample, obtaining behavior objects corresponding to user behaviors therein;
Step S201-4, within a selected target time window, generating the behavior object feature vectors corresponding to the target time window based on the behavior objects corresponding to the user behaviors.

Next, each of the above steps will be described in detail one by one.

Step S201-1, obtaining user behavior sample sequences.

This step collects samples according to the time sequence of user behavior occurrence, and records the user behavior samples in time order to form a serialized user behavior sample, i.e., a user behavior sequence sample.

Here, the user behavior sequence sample is explained. In the embodiments of the present application, the data generated by user behavior is processed into user behavior samples on the server side, such as click behavior data sample (user behavior sample 1), browsing behavior data sample (user behavior sample 2), . . . , add-to-cart behavior data sample (user behavior sample x), etc. Due to the diversity and time sequence of user behavior, the user behavior samples can be formed into a user behavior sequence sample for the corresponding user according to the time sequence of user behavior occurrence, following a timeline.

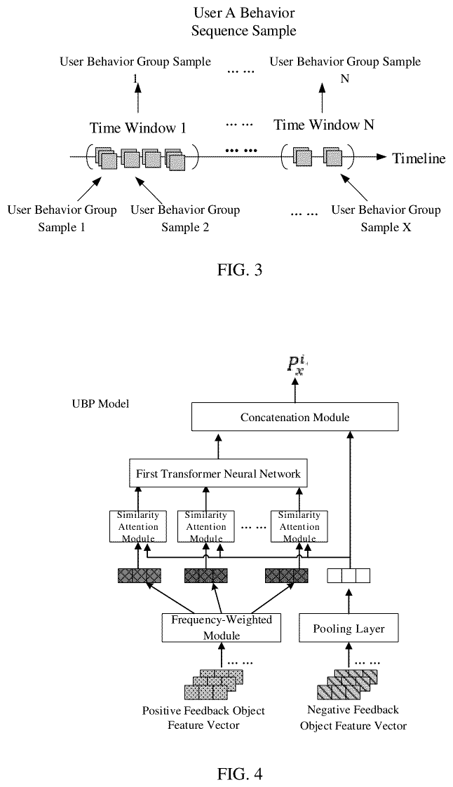

For ease of understanding, please refer to FIG. 3, which is a schematic diagram of user A's behavior sequence sample corresponding to this embodiment. As shown in FIG. 3, multiple user behavior samples of user A are represented as “ [symbol] ” in the figure. Since user A has multiple user behavior samples, from user behavior sample 1 to user behavior sample x, the user A behavior sequence sample arranged according to the timeline in FIG. 3 can be formed.

Step S201-2, performing a grouping process on the user behavior sequence sample corresponding to a preset time window to obtain a user behavior group sample corresponding to each time window.

This step performs a grouping process on the user behavior sequence sample collected in the above step S201-1 according to a preset time window to obtain a user behavior group sample corresponding to each time window.

The grouping process is specifically a process based on the division of the time window. The time window, as mentioned before, is a window dynamically preset by the preliminary interest feature representation acquisition model (UBP model) based on time parameters for dividing a user behavior sequence sample.

Continuing to refer to the illustration in FIG. 3, the user A behavior sequence sample can be grouped according to multiple preset time windows to obtain N user behavior group samples corresponding to N time windows. For example, based on the multiple user behavior samples generated by user A's shopping account in the past year, a user A behavior sequence sample is formed, and N groups of user behavior group samples corresponding to the N time windows are obtained according to the preset N time windows. Among them, each specific time window corresponds to the user behavior data collected within the time range of that time window, and the user behavior sequence sample collected in each specific time window serves as one user behavior group sample.

Step S201-3, for each the user behavior group sample, obtaining behavior objects corresponding to user behaviors therein.

This step is for obtaining the behavior objects corresponding to the user behaviors in the user behavior group sample, that is, for each user behavior group sample, based on the user behavior sample in that group sample and the behavior objects associated with the user behaviors, the behavior objects corresponding to the user behavior samples can be obtained. For example, if a user behavior sample records that a user clicked on product A, then in that user behavior sample, the behavior object corresponding to the user behavior of clicking, which is product A, is the behavior object corresponding to that user behavior sample.

For example, during the last login of user A's shopping account, a purchase behavior for product X occurred. Then, based on the data generated by the above purchase behavior, user behavior sample 1 is obtained. Based on the user behavior sample of this purchase behavior and the correlation, the behavior object is obtained as product X. A user behavior sample includes at least a user ID, a user behavior (click, browse, purchase, etc.), a behavior object (such as the specific product clicked, the specific product browsed, the specific product purchased, etc.), and the time of occurrence. The sample can be assigned to a certain time window based on the time of occurrence. Within a selected target time window, the behavior objects corresponding to the contained behavior samples can be determined based on the content contained in each of the user behavior samples.

Step S201-4, within a selected target time window, generating the behavior object feature vectors corresponding to the target time window based on the behavior objects corresponding to the user behaviors.

This step performs mathematical processing, specifically vectorization, on the behavior objects corresponding to the user behaviors determined in the previous step for subsequent use.

The user behavior corresponds to the behavior object, and the behavior object further corresponds one-to-one with the user's behavior object feature vector.

The above user's behavior object feature vector is an abstract feature representation of the behavior object in a high-dimensional space, which can be used to represent the abstract features corresponding to the behavior object. If the behavior object is not expressed as an abstract behavior object feature vector, it is impossible to perform various mathematical processing in the subsequent various models to obtain the underlying patterns. For example, if the behavior object is “XX mobile phone, model: A1,” this textual expression of the behavior object cannot be used to abstract the hidden features with other behavior objects. However, after expressing it using a vector, the correlation patterns between them can be found through the subsequent training process.

A behavior object feature vector includes a positive feedback object feature vector and a negative feedback object feature vector. For some behavior objects, if they are clicked or browsed, they are considered positive feedback objects. For some behavior objects, although they are displayed to the user, the user does not click, purchase, or browse them, but directly turns the page, they are considered negative feedback objects. After the above behavior objects are vectorized and expressed as feature vectors, they become positive feedback object feature vectors and negative feedback object feature vectors. For ease of understanding, please refer to the illustration in FIG. 4. FIG. 4 is a UBP model architecture diagram corresponding to the first embodiment of the present application. As shown in FIG. 4, the user's positive feedback object feature vector is represented by “ [symbol] ” in the figure; the user's negative feedback object feature vector is represented by “ [symbol] ” in the figure.

In the above steps, after obtaining the behavior objects corresponding to the user behaviors for each of the user behavior group samples, within a specific selected target time window, the behavior object feature vectors corresponding to the target time window are generated based on the behavior objects corresponding to the user behaviors. That is, a corresponding feature vector is generated based on the behavior object corresponding to the user behavior to achieve a mathematical expression of that behavior object.

In particular, the generating the behavior object feature vectors corresponding to the target time window based on the behavior objects corresponding to the user behaviors within the selected target time window includes:
Step S201-4-1, filtering the behavior objects of the user in the selected target time window according to a preset filtering condition to obtain sample behavior objects;
Step S201-4-2, generating the behavior object feature vectors corresponding to the target time window based on the sample behavior objects.

In particular, the preset filtering condition includes one or more of the following factors: a frequency of the user's behavior towards a behavior object reaches a preset value, a time duration of the user's behavior towards a behavior object reaches a preset value, or a type of the user's behavior towards a behavior object conforms to a preset type.

In this embodiment, the filtering the behavior objects of the user in the selected target time window includes filtering the positive feedback objects and negative feedback objects separately according to the type of the behavior object. For example, obtain the behavior objects corresponding to the user behavior of user A in time window 1 (target time window) under the corresponding user behavior group sample 1. According to the type of behavior object: filter the positive feedback objects corresponding to positive feedback behaviors from high to low behavior frequency, and set a preset behavior frequency threshold to obtain the top n positive feedback sample behavior objects corresponding to the positive feedback objects that meet the preset value; or, filter the negative feedback objects corresponding to negative feedback behaviors based on the time duration of collecting and adding the object to the cart, and determine the negative feedback objects that meet the set time preset value as negative feedback sample behavior objects. The sample behavior objects obtained through the above preliminary screening of behavior objects have higher credibility in the process of generating user interest features. An example of the preset type is purchase, add to cart, click to browse, collect, or share with other users. The above preset filtering conditions and preset types can be combined and adjusted according to the needs of the actual scene, and this embodiment is an illustrative example and not an actual limitation.

In a specific implementation, based on the type of sample behavior objects obtained, i.e., positive feedback sample behavior objects and negative feedback sample behavior objects, the behavior object feature vector for representing the user's behavior objects corresponding to the user behavior group sample of the target time window is generated respectively, and correspondingly, the positive feedback object feature vector and the negative feedback object feature vector are obtained.

In the embodiments of the present application, the above process of generating the behavior object feature vectors corresponding to the target time window is implemented in the input layer module. The input layer module constructs and generates the behavior object feature vectors for representing the user's behavior objects by extracting features from the behavior objects used to represent the user. Using the relevant data of the user's behavior objects pre-stored in the UBP model, it is input into the input layer for data processing such as processing, cleaning, and dimensionality reduction to generate the behavior object feature vector. In this embodiment, the above input layer module can be set in the UBP model, or it can be pre-set before the UBP model. The setting method can be adjusted according to specific practical needs, and this embodiment does not have specific limitations on this. There can be multiple specific implementation methods for the above input layer. For example, it can be understood as an encoding process, implemented by an encoding module; or understood as an embedding layer.

It should be understood that the above process of filtering the behavior objects corresponding to user behaviors is to filter the behavior objects in each target time window. In other words, with the time window as the unit, the user's behavior objects in multiple time windows are executed separately. The current time window in which the behavior objects are being processed is called the target time window, and the sample behavior objects corresponding to each time window are obtained by filtering. Furthermore, the above filtering process is to filter the user's positive feedback objects and negative feedback objects separately in each time window.

S202, performing an aggregation calculation on the negative feedback object feature vectors to obtain an aggregated negative feedback object vector corresponding to the negative feedback object feature vectors.

This step is for obtaining the aggregated negative feedback object vector corresponding to the negative feedback object feature vectors.

The aggregation calculation is to aggregate the various negative feedback object feature vectors obtained in step S201 into a unified vector, which can be done in various ways, typically using max pooling or average pooling operations. This step can be implemented by the pooling layer in FIG. 4.

The pooling refers to reducing the dimensionality of data by imitating the human visual system, using higher-level features to represent the original data, aiming to reduce information redundancy and improve calculation speed. Pooling operations can take different forms, including: max pooling, average pooling, etc.

The aggregated negative feedback object vector is a centralized representation of the user's negative feedback object feature vectors, that is, forming a vector that can reflect their common properties by processing each negative feedback object feature vector through pooling.

Referring to the illustration in FIG. 4, the abstract identifier of the above aggregated negative feedback object vector is indicated as “ [symbol] ” in FIG. 4. The aggregation calculation of the above negative feedback object feature vector is completed in the pooling Layer module of the UBP model. By performing max pooling or average pooling operations on the multiple negative feedback object feature vectors “ [symbol] ” corresponding to each user behavior group sample in different time windows, the aggregated negative feedback object vector “ [symbol] ” representing the user can be obtained.

S203, calculating a correlation between the aggregated negative feedback object vector and each of the positive feedback object feature vectors.

This step is for obtaining the correlation of each positive feedback object feature vector.

In a specific implementation, the above correlation is an attention mechanism based on Euclidean distance, and the correlation between the aggregated negative feedback object vector and each of the positive feedback object feature vectors is calculated and obtained. For example, the attention mechanism is used to perform a dot product operation on the aggregated negative feedback object vector and the positive feedback object feature vector, and the dot product result is normalized to obtain the correlation.

The Euclidean distance and similarity attention (attention mechanism) involved are explained below. Euclidean distance is used to measure the straight-line distance between two points in Euclidean space. In deep learning, Euclidean distance can be used to measure the degree of difference or correlation between two feature vectors. Similarity attention, attention mechanism: originating from cognitive science, in the field of machine learning, models often need to receive and process a large amount of data. However, at a specific moment, often only a small part of certain data is more important. These data will be given more weight during the processing. The weighting mechanism based on this is usually called the attention mechanism. Introducing the attention mechanism can reduce the amount of information to be processed and the required computing resources.

It should be understood here that since the correlation can reflect the degree of similarity or proximity between the positive feedback object feature vector and the aggregated negative feedback object vector, the calculated correlation parameter can reflect the degree of credibility of each positive feedback object feature vector, referred to as confidence level. Confidence level is the probability that the true value appears within the allowable error range, centered on the estimated value. Confidence level reflects the degree of reliability of the data. Therefore, the obtained correlation parameter can be used for the generation of the user's preliminary interest feature representation in subsequent steps.

S204, generating a preliminary interest feature representation of the user corresponding to the target time window based on the correlation, the positive feedback object feature vectors, and the aggregated negative feedback object vector.

This step is for obtaining the user's preliminary interest feature representation corresponding to the target time window.

The preliminary interest feature representation is a phased representation of the user's interest features, which can reflect the user's interest features corresponding to the above target time window. For example, corresponding to the behavior object feature vector for representing the user's behavior objects obtained in step S201 for time window 1, what is obtained is the behavior object feature vector of user A's shopping account within one day (time window 1). Then, the preliminary interest feature representation generated in the above step S204 is the preliminary interest feature representation of user A within one day (time window 1). The above preliminary interest feature representation, as a phased feature representation, can partially or completely serve as the user's interest feature representation.

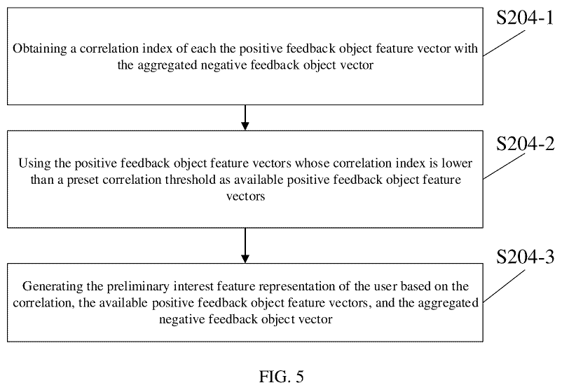

In particular, the generating the preliminary interest feature representation of the user corresponding to the target time window based on the correlation, the positive feedback object feature vectors, and the aggregated negative feedback object vector includes the following steps, as shown in the illustration in FIG. 5, which is a flowchart for generating the user's preliminary interest feature representation, including the following steps:

S204-1, obtaining a correlation index of each the positive feedback object feature vector with the aggregated negative feedback object vector.

The correlation can reflect the degree of similarity or proximity between the positive feedback object feature vector and the aggregated negative feedback object vector. The correlation index, as a reflection of the degree of similarity or proximity between the two feature vectors, can be used to represent the degree of closeness between behavior objects. In this embodiment, the correlation index can be presented as a number from 0 to 1, in matrix form, or in list form. Corresponding to the UBP model in FIG. 4, the above correlation index is calculated and obtained in the similarity attention module (attention mechanism module). By inputting each positive feedback object feature vector and the aggregated negative feedback object vector into the attention mechanism module, the correlation index corresponding to each positive feedback object feature vector can be obtained. In a specific implementation, the aggregated negative feedback object vector serves as a reference vector in the calculation process of each positive feedback object feature vector. By calculating the correlation index of each positive feedback object feature vector with the aggregated negative feedback object vector, the degree of closeness or similarity between each pair of positive feedback object feature vectors can be indirectly known. The above correlation index can be calculated using the cosine similarity algorithm, Euclidean distance algorithm, or Pearson correlation coefficient algorithm. In addition, other similarity algorithms can also be used, and this embodiment does not limit this.

S204-2, using the positive feedback object feature vectors whose correlation index is lower than a preset correlation threshold as available positive feedback object feature vectors;

Here, the process of filtering out the positive feedback object feature vectors that meet the threshold condition in this step is explained. When the number of user behaviors is limited, the behavior object feature vectors corresponding to noisy user behavior samples have a greater negative impact on the UBP model. Especially when the amount of positive feedback behavior is very small, if the positive feedback object feature vectors corresponding to the user's positive feedback behaviors are few in number and carry a large amount of noise, it will lead to a low proportion of personalization in the UBP model and the problem of recommendation fatigue. Therefore, it is currently necessary to filter out the positive feedback object feature vectors corresponding to positive feedback behaviors with low noise and high quality based on the correlation threshold, as available positive feedback object feature vectors. Among them, the correlation index can be used as a filtering basis, and the positive feedback object feature vectors with a correlation index lower than a preset correlation threshold are used as available positive feedback object feature vectors with low noise and high quality. The specific numerical setting of the above correlation threshold can be adjusted according to the needs of the actual scene, and this embodiment does not limit it. A correlation index lower than the threshold means that the correlation between the positive feedback object and the negative feedback object is low, and the probability of it being a true positive feedback object is high.

S204-3, generating the preliminary interest feature representation of the user based on the correlation, the available positive feedback object feature vectors, and the aggregated negative feedback object vector.

In this step, the generating the preliminary interest feature representation of the user based on the correlation, the available positive feedback object feature vectors, and the aggregated negative feedback object vector includes:
assigning a second weight to each of the available positive feedback object feature vectors in a preset manner based on the correlation of the available positive feedback object feature vectors with the aggregated negative feedback object vector, wherein the higher the correlation, the lower the weight;
generating the preliminary interest feature representation of the user using the aggregated negative feedback object vector and the weighted positive feedback object feature vectors.

In the process of assigning a second weight to each of the available positive feedback object feature vectors in a preset manner, the source of the second weight parameter is: the correlation index. Since the correlation index is an index corresponding to each positive feedback object feature vector generated with the aggregated negative feedback object vector as a reference during the acquisition process, the second weight parameter corresponding to each positive feedback object feature vector can be obtained based on the above correlation index.

Among them, the purpose of assigning a second weight to each of the available positive feedback object feature vectors is to reduce the proportion of the available positive feedback object feature vectors with lower second weight parameters in the user's preliminary interest feature representation, based on the weight in each available positive feedback object feature vector. That is to say, the more a positive feedback object differs from a negative feedback object, the more it is considered to be able to reflect the characteristics of the positive feedback object, and the greater its role in generating the subsequent preliminary interest feature vector.

In this embodiment, the generating the preliminary interest feature representation of the user using the aggregated negative feedback object vector and the weighted positive feedback object feature vectors includes:
S204-3-1, inputting each of the weighted positive feedback object feature vectors into a first transformer neural network to obtain an aggregated positive feedback object vector;
S204-3-2, fusing the aggregated positive feedback object vector and the aggregated negative feedback object vector to obtain the preliminary interest feature representation of the user.

Referring to the illustration in FIG. 4, in this embodiment, the first transformer neural network (transformer layer module) is shown in the module corresponding to the first transformer neural network in FIG. 4. The transformer layer is a deep learning model based on a self-attention mechanism, which learns context and thus potential meaning by tracking relationships in sequence data. In a specific implementation, after the above weighted positive feedback object feature vectors undergo deep learning in the transformer layer module, they can be centrally expressed as the user's aggregated positive feedback object vector. By weighting each positive feedback object feature vector with the second weight parameter, and then performing information interaction on the weighted positive feedback object feature vectors in the transformer layer module, the aggregated positive feedback object vector corresponding to the target time window can be obtained. The aggregated positive feedback object vector is an aggregated representation of the user's positive feedback objects in the target time window. In other words, the above aggregated positive feedback object vector can represent the expression of the user's phased interest features.

In step S204-3-2, fusing the aggregated positive feedback object vector and the aggregated negative feedback object vector to obtain the preliminary interest feature representation of the user.

In a specific implementation, the aggregated positive feedback object vector and the aggregated negative feedback object vector are jointly input into the concatenation module (concat module) of the UBP model for fusion processing to generate the user's preliminary interest feature representation. Among them, the fusing the aggregated positive feedback object vector and the aggregated negative feedback object vector uses concatenation in this embodiment. Certainly, the above fusion processing can also be vector addition or a matrix composed of multiple vectors. The preliminary interest feature representation is the interest feature representation corresponding to the target time window. That is, the above preliminary interest feature representation can be used as a phased interest feature representation of the user. Different user target time windows will result in different preliminary interest feature representations. As shown in FIG. 4, the user's preliminary interest feature representation can be expressed as

$${P}_{x ″}^{i} .$$

The above concat module: short for concatenate, is a common integration method for multi-channel features, which concatenates two or more feature vectors to obtain a new feature vector. In the new feature vector, the feature dimension is increased, and the information of the feature vectors before concatenation is retained.

Before the step of generating the preliminary interest feature representation of the user corresponding to the target time window based on the correlation, the positive feedback object feature vector, and the aggregated negative feedback object vector, the method can also include the following step:
assigning a first weight to a corresponding the positive feedback object feature vector based on a frequency of each the positive feedback object as a user behavior object.

In a specific implementation, by inputting each of the positive feedback object feature vectors into a frequency-weighted layer module for processing, the first weight parameter for each available positive feedback object feature vector can be obtained. Referring to the illustration of the UBP model in FIG. 4, after processing each available positive feedback object feature vector through the frequency-weighted module, the positive feedback object feature vector weighted with the first weight parameter corresponding to each positive feedback object feature vector is obtained. For example, the freq-weighted layer module, after obtaining the first weight parameter corresponding to each available positive feedback object feature vector, multiplies each available positive feedback object feature vector by the above first weight parameter to obtain the available positive feedback object feature vector weighted with the first weight parameter. Referring to the illustration in FIG. 4, the abstract identifier of the above available positive feedback object feature vector weighted with the first weight parameter is indicated as “ [symbol] ” in FIG. 4.

At the same time, in the step of generating the preliminary interest feature representation of the user corresponding to the target time window based on the correlation, the positive feedback object feature vector, and the aggregated negative feedback object vector, the available positive feedback object feature vectors assigned with the first weight are used.

Here, the purpose of assigning the first weight to the positive feedback object feature vector is to process the available positive feedback object feature vector with the first weight parameter obtained through the freq-weighted layer module (frequency-weight module) to obtain a high-quality available positive feedback object feature vector for generating the preliminary interest feature representation.

Through the method provided in the first embodiment, the preliminary interest feature representation of a specific user corresponding to a specific time window (target time window) can be obtained. This interest feature representation actually reflects the user's interest as reflected by the user behavior samples obtained in that target time window.

Since a user may exhibit different interest features in different time windows, in the subsequent method for predicting user behavior objects, the interest feature representations of each time window can also be fused to form a high-level interest feature representation of the target user. For details, see the relevant description in the third embodiment.

### Second Embodiment

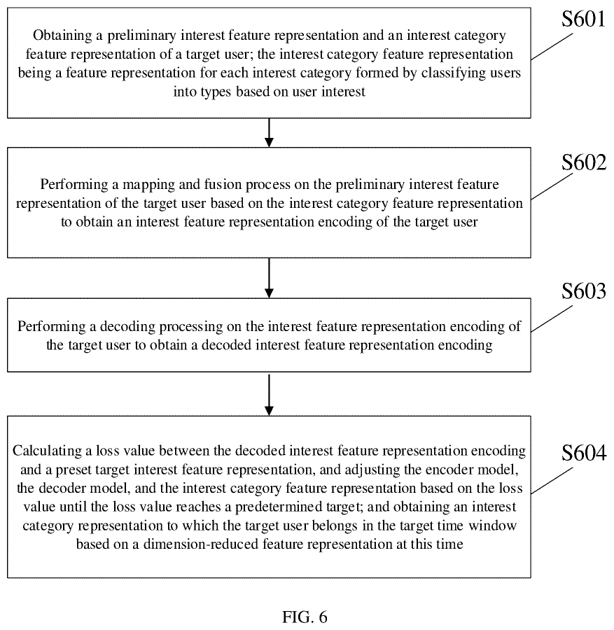

The following introduces the method embodiment for user interest feature clustering provided by the present application in conjunction with FIG. 6. Please refer to FIG. 6, which is a schematic flowchart of the second embodiment of the present application. This method embodiment is applied to the interest group feature representation acquisition model (UBC model), and the method includes the following steps:

Step S601, obtaining a preliminary interest feature representation and an interest category feature representation of a target user; the interest category feature representation being a feature representation for each interest category formed by classifying users into types based on user interest.

This step is for obtaining the preliminary interest feature representation and the interest category feature representation. In a specific implementation, a high-level interest feature representation of the target user can also be obtained.

When the target user's user behavior is scarce, highly sparse, and has a large time interval between behaviors, user interest feature clustering can be achieved by obtaining a high-quality, high-confidence preliminary interest feature representation and the interest category feature representation provided by the UBC model.

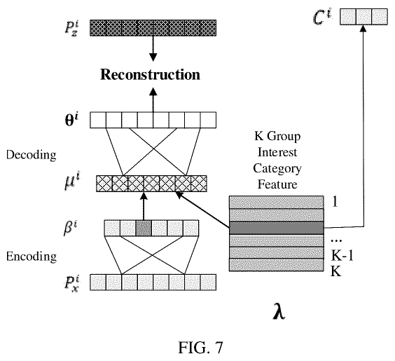

To facilitate understanding of this embodiment, please also refer to FIG. 7, which shows the architecture diagram of the interest group feature representation acquisition model (UBC model) to which this method is applied. The overall UBC model is a semi-supervised autoencoder, with a corresponding encoder and decoder. Different from common autoencoders, in a specific implementation, this semi-supervised autoencoder also needs to obtain an interest category feature representation and a high-level interest feature representation of the target user to achieve the processing of user interest feature clustering.

In particular, the target user is a user who has a need for interest category clustering. In other words, the target user is a user who obtains the interest category feature representation corresponding to their own interest group based on their own preliminary interest feature representation.

Here, the interest category feature representation obtained by the UBC model is described in detail. The above interest category feature representation for user interest feature clustering is an interest category feature representation obtained by the UBC model through learning and training. That is, the above obtained interest category feature representation is a randomly initialized feature representation. Under normal circumstances, during the training process of the UBC model, the randomly initialized interest category feature representation and the randomly initialized encoder and decoder parameters are continuously adjusted to finally obtain the interest category feature representation, encoder parameters, and decoder parameters for user interest feature clustering. In other words, the above randomly initialized interest category feature representation, encoder parameters, and decoder parameters need to be continuously learned and adjusted before they can be used in the process of user interest feature clustering. In a specific implementation, the randomly initialized interest category feature representation is used as the input of the UBC model. Through the training of the UBC model, the above randomly initialized interest category feature representation is continuously learned and adjusted, and the adjustment of the encoder and decoder parameters of the above UBC model finally obtains the interest category feature representation, as well as the encoder parameters and decoder parameters, applied to user interest feature clustering.

The preliminary interest feature representation of the target user is a phased representation of the target user's interest features, which can reflect the user's interest features corresponding to the target time window. Among them, generating the preliminary interest feature representation of the target user includes:
obtaining behavior object feature vectors corresponding to a target time window and configured to represent behavior objects of the target user; each of the behavior object feature vectors configured to represent a behavior object of the target user including a positive feedback object feature vector and a negative feedback object feature vector;
performing an aggregation calculation on the negative feedback object feature vectors to obtain an aggregated negative feedback object vector corresponding to the negative feedback object feature vectors;
calculating a correlation between the aggregated negative feedback object vector and each of the positive feedback object feature vectors;
generating the preliminary interest feature representation of the target user corresponding to the target time window based on the correlation, the positive feedback object feature vectors, and the aggregated negative feedback object vector.

For the specific implementation process of generating the preliminary interest feature representation of the target user corresponding to the target time window, please refer to the description of the first embodiment of the present application, which will not be repeated here.

In a specific implementation, the source of the interest category feature representation is the interest category feature representation corresponding to interest groups formed by the UBC model through pre-set type classification and learning adjustment on multiple user interest data from numerous users in the UBC model. That is, the UBC model can collect a large amount of user interest data from multiple users, divide the above user interest data into groups, and form a randomly initialized interest category feature representation corresponding to multiple interest categories. By learning and adjusting the randomly initialized interest category feature representation, the interest category feature representation applied to the target user's interest feature clustering is finally formed. Referring to the illustration in FIG. 7, in the UBC model, a total of K groups (K group) of interest categories are formed, including interest category 1, interest category 2, . . . , interest category K. These K interest types correspond to the K group embedding. In FIG. 7, the vector feature representation “λ” corresponding to the K group interest category feature representation on the right is represented, and the target user's interest feature representation encoding “λ” is composed of interest feature representation encoding “λ⁰” . . . “λ^{K-1}” etc. The interest feature representation encoding “λ” matrix is composed of K group interest category feature representation vectors, and the dimension of each vector is D. The above K is a pre-defined parameter, determined as needed; the dimension D of the vector feature representation “λ” is also a parameter that needs to be pre-defined, determined as needed, for example, 32, 64, 128 are selected as the specific value of dimension D. It should be noted that the data dimensions “λ” and D of the data represented by the corresponding “λ” matrix are consistent with the data dimensions of the dimension-reduced feature representation “βⁱ” and the target user's interest feature representation encoding “μⁱ” in the subsequent steps, respectively. For example, the above interest feature representation encoding “λ” has K group interest category feature representation vectors, the corresponding data dimension of the dimension-reduced feature representation “βⁱ” is also K, the dimension of each group of interest category feature representation vectors of “λ” is D, and the corresponding data dimension of the target user's interest feature representation encoding “μⁱ” is also D. The one-to-one correspondence of the feature representation data dimensions here is to facilitate the one-to-one mapping of the vectors according to the vector feature dimensions when the vectors corresponding to each feature representation are mapped and fused.

To facilitate understanding of the process of obtaining the interest category feature representation, an example is given. The UBC model, based on multiple user interest data, analyzes and obtains 3 types of user interests: interest category 1—promotional activities, interest category 2—fitness equipment, interest category 3—movies. The interest category feature representations “λ¹”, “λ²”, and “λ³” representing the above 3 categories are formed into an overall interest category feature representation “λ”. Furthermore, the above interest category feature representation “λ” is obtained through learning and adjustment of a randomly initialized interest category feature representation. It should be emphasized that the randomly initialized interest category feature representation itself can be a completely meaningless way of dividing interest categories, just to have a starting point. The actual division method of the final interest category feature representation is entirely the result of machine learning on a large number of samples. Of course, it is not excluded that the initial interest category division as a starting point has a certain meaning, but this meaning will not really limit the final interest category, it only affects the adjustment process of obtaining the final interest category, and this artificially set meaning is not necessarily a positive influence.

Step S602, performing a mapping and fusion process on the preliminary interest feature representation of the target user based on the interest category feature representation to obtain an interest feature representation encoding of the target user.

This step is for obtaining the interest feature representation encoding of the target user.

Corresponding to the illustration in FIG. 7, the above preliminary interest feature representation of the target user is represented by

$${P}_{x}^{i ″}$$

in the figure. The interest category feature representation is identified by “λ”. The encoder maps the above

$${P}_{x}^{i ″}$$

from high-dimensional data to low-dimensional data with loss by reducing the amount of data, to obtain an encoded dimension-reduced feature representation “βⁱ”. Then, the dimension-reduced feature representation “βⁱ” and the interest category feature representation “λ” are subjected to a mapping and fusion process to obtain the target user's interest feature representation encoding “μⁱ”. The above mapping and fusion process is a fusion between vectors, and the specific processing method can adopt existing technologies such as weighted sum operations. For example, the following formula is used for the mapping and fusion process, where

$${β}_{h}^{i ″}$$

in the formula corresponds to the h-th dimension (vector length is k-dimensional) of the above encoded dimension-reduced feature representation “βⁱ” in the i-th time window, and

$${g}_{s}^{i ″}$$

corresponds to the s-th row of the above interest category feature representation “λ” in the i-th time window, and the vector length is D.

$${μ}^{i} = {\sum }_{h = 1}^{k} {β}_{h}^{i} {g}_{s}^{i}$$

In a specific implementation, the dimension-reduced feature representation “βⁱ” obtained after the encoder encoding process is a feature representation containing a third weight parameter. That is, the dimension-reduced feature representation “βⁱ” obtained through the encoder processing can reflect the feature representation weight.

The above target user's interest feature representation encoding “μⁱ” can represent the interest features of the target user, and the target user's interest feature representation encoding “μⁱ” is a feature representation that fuses the interest category feature representation “λ” and the dimension-reduced feature representation “βⁱ”. In this embodiment, the data dimension of the dimension-reduced feature representation “βⁱ” after encoding by the encoder corresponds one-to-one with the data dimension of the K group interest category feature representation “λ” in the UBC model, and at the same time, the dimension D of each group of interest category feature representation corresponds one-to-one with the data dimension of the target user's interest feature representation encoding “μⁱ”. In other words, the encoded dimension-reduced feature representation “βⁱ” has K dimensions, the corresponding interest category feature representation “λ” has K groups, each group has a dimension of D, and the target user's interest feature representation encoding “μⁱ” has D dimensions. In a specific implementation, the UBC model can pre-set the number of groups and the dimension of each group of the user interest category feature representation, that is, the number of interest category groups and the length of each group of vectors, and then the dimension of the encoded dimension-reduced feature representation “βⁱ” can be determined. The specific process of mapping and fusing the dimension-reduced feature representation “βⁱ” with the interest category feature representation “λ” to obtain the target user's interest feature representation encoding “μⁱ” is: according to the one-to-one correspondence of data dimensions, the third weight parameter and vector on each dimension of the dimension-reduced feature representation “βⁱ” and the vector of the interest category feature representation “λ” are respectively subjected to vector multiplication and summation operations. Illustratively, obtain the third weight parameter

$${β}_{h}^{i ″}$$

of the dimension-reduced feature representation “βⁱ” in the i-th time window and with “h=1” (the first dimension of the data dimension); at the same time, obtain the interest category feature vector

$${g}_{s}^{i ″}$$

in the s-th row of the i-th time window in the interest category feature representation “λ”. First, multiply the weight parameter

$${β}_{h}^{i ″}$$

of each group by the corresponding interest feature vector

$${g}_{s}^{i ″}$$

of each group, then add the corresponding dimensions of the interest category feature representation vectors after the weight multiplication, and finally obtain the D-dimensional target user's interest feature representation encoding “μⁱ”.

Step S603: performing a decoding process on the interest feature representation encoding of the target user to obtain a decoded interest feature representation encoding.

This step is for obtaining the decoded interest category feature representation.

It should be noted in this step that, different from the usual encoding-decoding process, in a specific implementation, during the decoding process of the interest feature representation encoding “μⁱ”, the learning direction of the decoding is the high-level interest feature representation

$${P}_{z ″}^{i}$$

of the target user. In this step, by setting the decoding learning direction of “μⁱ” which maps the preliminary interest representation and the interest clustering representation to the high-level interest feature representation

$${P}_{z ″}^{i}$$

of the target user, the result of the interest clustering can be made closer to the high-level interest feature representation of the target user, achieving a better clustering effect. The decoded interest feature representation encoding thus obtained can better reflect the characteristics of the target user as a user belonging to a certain category.

In a specific implementation, the above target user's interest feature representation encoding “μⁱ” is processed in the decoder. By increasing the amount of data, the low-dimensional target user's interest feature representation encoding “μⁱ” is mapped to a high-dimensional decoded interest feature representation encoding “θⁱ”.

Step S604, calculating a loss value between the decoded interest feature representation encoding and a preset target interest feature representation, and adjusting the encoder model, the decoder model, and the interest category feature representation based on the loss value until the loss value reaches a predetermined target; and obtaining an interest category representation to which the target user belongs in the target time window based on a dimension-reduced feature representation at this time.

This step is for obtaining the interest category representation to which the target user belongs.

In particular, the target interest feature representation uses the preliminary interest feature representation of the user, or uses a high-level interest feature representation; the high-level interest feature representation is obtained after performing an association process on the preliminary interest feature representation of the target time window and preliminary interest feature representations of other time windows.

In this embodiment, specifically: the loss value between the decoded interest feature representation encoding “μⁱ” obtained by decoding the interest feature representation encoding “θⁱ” and the high-level interest representation

$${P}_{z ″}^{i}$$

is calculated by a loss function to obtain the above loss value. The loss value can be used to measure the feature representation information lost due to compression. The loss value reaching a predetermined target can mean that the loss value is less than a preset threshold. According to the illustration in FIG. 7, when the loss value is less than the preset threshold, the interest category representation “Cⁱ” to which the target user belongs in the target time window is obtained based on the dimension-reduced feature representation “βⁱ” in the model at this time. The process of obtaining the interest category representation “Cⁱ” based on the dimension-reduced feature representation “βⁱ” at this time is illustrated as follows: based on the row vector of the interest category feature representation corresponding to the dimension with the largest vector value in the dimension-reduced feature representation “βⁱ” vector at this time. For example, the data dimension of the dimension-reduced feature representation “βⁱ” at this time is 3. In the model training process, the vector values of the dimension-reduced feature representation “βⁱ” on the above 3 data dimensions in one round of learning and training are “the value of the 1st dimension is 0.1, the value of the 2nd dimension is 0.8, the value of the 3rd dimension is 0.2”. By comparing the values, it can be seen that the value of the 2nd dimension is the largest. Therefore, the second row of the interest category feature representation “λ” vector is used as the output result of the UBC model, that is, the interest category representation “Cⁱ” to which the target user belongs in the target time window. Furthermore, the obtained interest category representation “Cⁱ” can also be used as input data in the UBC model training process to participate in subsequent calculations until the training converges.

It should be understood that the preliminary interest feature representation

$${P}_{x}^{i} ”$$

and the high-level interest feature representation

$${P}_{z}^{i} ”$$

are feature representations with a progressive relationship. The above high-level interest feature representation

$${P}_{z}^{i} ”$$

is a feature representation obtained based on the preliminary interest feature representation

$${P}_{x}^{i} ” .$$

The high-level interest feature representation

$${P}_{z}^{i} ”$$

not only includes the interest features of the time window it is in, but also considers the factors of other time windows. That is, for any target time window, the high-level interest feature representation

$${P}_{z}^{i} ”$$

not only considers the user interest features reflected by that time window, but also considers the user interest features reflected by other time windows to a certain extent. By calculating the loss value between the decoded interest feature representation encoding and the high-level interest feature representation

$${P}_{z}^{i} ” ,$$

the obtained interest category representation “Cⁱ” can be closer to the interest features of the target user.

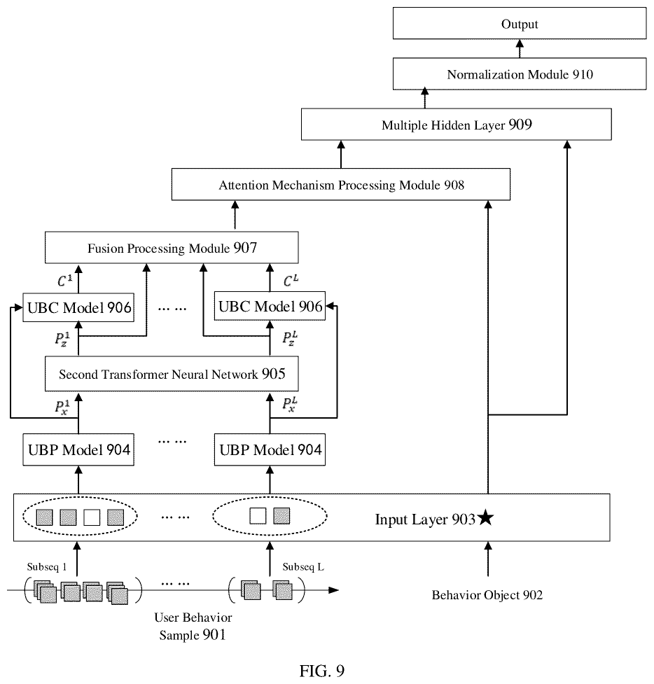

The above high-level interest feature representation is obtained after performing an association process on the preliminary interest feature representation of the target time window and the preliminary interest feature representations of other time windows. Specifically, the second transformer neural network 905 shown in FIG. 9 can be used to process the preliminary interest feature representation

$${P}_{x}^{i} ”$$

of each time window to form a corresponding high-level interest feature representation

$${P}_{z}^{i} ”$$

for each time window. As mentioned before, the high-level interest feature representation reflects the interest features of the current time window and also absorbs the interest features of the user in other time windows.

In the step S604, the preset target interest feature representation uses the high-level interest feature representation to achieve a semi-supervised effect. Certainly, it is not excluded to directly use the preliminary interest feature representation, which would be an unsupervised effect.

Each time window has a UBC module, and a user interest clustering representation will be learned for different time windows, because user interests will change in different time windows.

### Third Embodiment

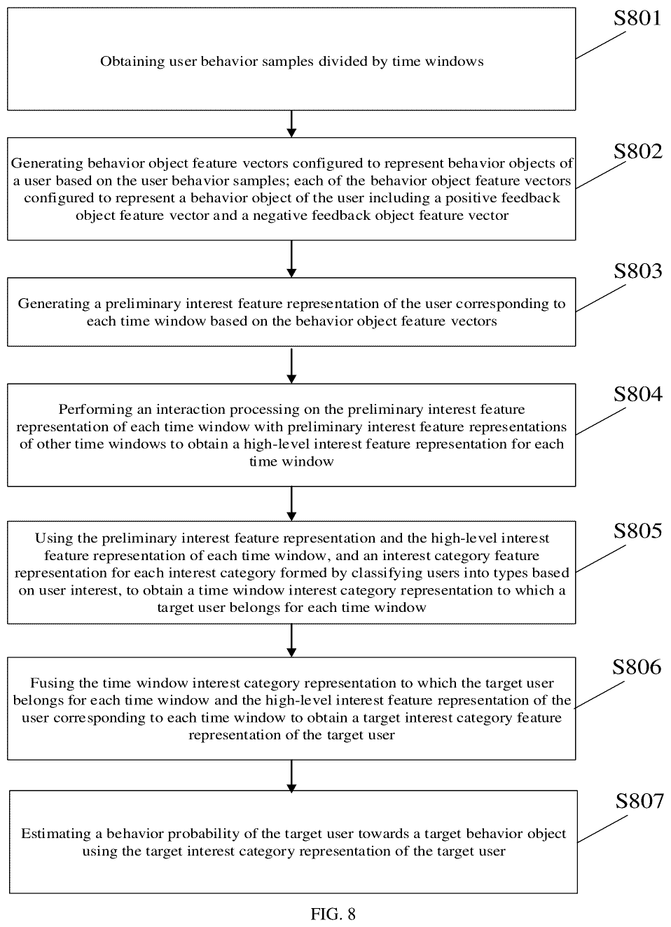

The following introduces a user behavior object prediction method embodiment provided by the present application in conjunction with FIG. 8. Please refer to FIG. 8, which is a schematic flowchart of the third embodiment of the present application. This method embodiment is applied to the user behavior object prediction model (HIM model); for the HIM model, please refer to FIG. 9; it can be seen that the HIM model includes the UBP model and the UBC model.

Step S801, obtaining user behavior samples divided by time windows.

This step is for obtaining user behavior samples, which are the basis for analyzing the interest features of a specific user in this method. These user behavior samples are a series of behavior samples of a user arranged in chronological order, so as a whole, they can be called a user behavior sequence sample.

The meaning of the user behavior sample, etc., has been specifically explained in the description of step S201-1 in the first embodiment of the present application, in conjunction with FIG. 3, and will not be repeated here.

The meaning of the time window has been described in detail in the description of step S201 in the first embodiment, and will not be repeated here.

Step S802, generating behavior object feature vectors configured to represent behavior objects of a user based on the user behavior samples; each of the behavior object feature vectors configured to represent a behavior object of the user including a positive feedback object feature vector and a negative feedback object feature vector.

For the process of generating a user behavior object feature vector from the user behavior sample, please refer to the description of step S201 in the first embodiment. In this embodiment, step S201 of the first embodiment is just rephrased, emphasizing that the behavior object feature vector is obtained through the user behavior sample. The specific implementation of generating the behavior object feature vector from the behavior object is formed by the processing of the input layer 903 in FIG. 9, and this formation process has been described in the first embodiment.

Step S803, generating a preliminary interest feature representation of the user corresponding to each time window based on the behavior object feature vectors.

This step is a summary of the first embodiment; it is specifically executed by the UBP model 904 in FIG. 9. It should be noted that the generated preliminary interest feature representation corresponds to each time window, that is, for each time window where user behavior samples are obtained a corresponding preliminary interest feature representation

$${P}_{x}^{i} ”$$

is generated, specifically:

$${P}_{x}^{1} … {P}_{x}^{L} ” .$$

This step can be further divided into the following specific steps:
Step S803-1, obtaining behavior object feature vectors corresponding to a target time window and configured to represent behavior objects of the user; each of the behavior object feature vectors configured to represent a behavior object of the user including a positive feedback object feature vector and a negative feedback object feature vector;
Step S803-2, performing an aggregation calculation on the negative feedback object feature vectors to obtain an aggregated negative feedback object vector corresponding to the negative feedback object feature vectors;
Step S803-3, calculating a correlation between the aggregated negative feedback object vector and each of the positive feedback object feature vectors;
Step S803-4, generating the preliminary interest feature representation of the user corresponding to the target time window based on the correlation, the positive feedback object feature vectors, and the aggregated negative feedback object vector.

The above specific process has been described in detail in the first embodiment and will not be repeated here.

Step S804, performing an interaction processing on the preliminary interest feature representation of each time window with preliminary interest feature representations of other time windows to obtain a high-level interest feature representation for each time window.

In this step, for each time window, a high-level interest feature representation is generated based on the preliminary interest feature representation. The high-level interest feature representation is obtained by providing the preliminary interest feature representation to the second transformer neural network 905 for conversion. The high-level interest feature representation not only includes the interest features of the current time window but also considers factors from other time windows. That is, for any target time window, the high-level interest feature representation considers both the user interest features reflected by that time window and, to a certain extent, the user interest features reflected by other time windows, while still primarily focusing on the interest features of the target time window. The implementation of the second transformer neural network 905 (transformer layer) can be achieved using a transformer model. A transformer model is a neural network that learns context and thus meaning by tracking relationships in sequence data.

The transformer model applies a set of evolving mathematical techniques, called attention or self-attention, to detect implicit relationships where even distant data elements in a series influence and depend on each other.

The process, principle, etc., of generating the high-level interest feature representation from the preliminary interest feature representation are also introduced in step S604 of the second embodiment and can be referred to. In a specific implementation, the preliminary interest feature representation

$${P}_{x}^{1} ”$$

undergoes an interaction process to obtain the high-level interest feature representation

$${P}_{z}^{1} ”$$

for time window 1; the preliminary interest feature representation

$${P}_{x}^{L} ”$$

undergoes an interaction process to obtain the high-level interest feature representation

$${P}_{z}^{L} ”$$

for time window L.

Step S805, using the preliminary interest feature representation and the high-level interest feature representation of each time window, and an interest category feature representation for each interest category formed by classifying users into types based on user interest, to obtain a time window interest category representation to which a target user belongs for each time window.

This step obtains the time window interest category representation of the user for the corresponding time window through the preliminary interest feature representation, high-level interest feature representation, and interest category feature representation obtained in the previous steps.

This step is basically a summary of the second embodiment, with the difference being that this step emphasizes that the interest category representation is obtained corresponding to the time window, and the obtained result is called the time window interest category representation, to distinguish it from the interest category representation of the target user formed by fusing the interest category representations of each time window in the subsequent steps. In a specific implementation, the preliminary interest feature representation

$${P}_{x ″}^{i}$$

and the high-level interest feature representation

$${P}_{z ″}^{i}$$

under time window 1 are jointly input into the UBC model for processing to obtain the interest category representation “C¹” of the target user corresponding to time window 1. Similarly, in different time windows of the target user, the interest category representation “C¹, Cⁱ . . . C^{L}” for that time window can be obtained respectively.

Specifically, this step can include the following specific steps:
Step S805-1, obtaining a preliminary interest feature representation and an interest category feature representation of the target user corresponding to a target time window;
Step S805-2, performing a mapping and fusion process on the preliminary interest feature representation of the target user based on the interest category feature representation to obtain an interest feature representation encoding of the target user;
Step S805-3, performing a decoding processing on the interest feature representation encoding of the target user to obtain a decoded interest feature representation encoding;
Step S805-4, calculating a loss value between the decoded interest feature representation encoding and the high-level interest feature representation of the user in the target time window, and adjusting the encoder model, the decoder model, and the interest category feature representation based on the loss value until the loss value reaches a predetermined target; and, based on the dimension-reduced feature representation at this time, obtain the interest category representation to which the target user belongs in the target time window.

For the specific process and meaning of the above steps, please refer to the description of the second embodiment of the present application.

Step S806, fusing the time window interest category representation to which the target user belongs for each time window and the high-level interest feature representation of the user corresponding to each time window to obtain a target interest category feature representation of the target user.

This step is implemented by the fusion processing module 907; its purpose is to obtain a target interest category feature representation that reflects the overall situation of the target user by combining the time window et interest category representation “Cⁱ” and the high-level interest feature representation

$${P}_{z ″}^{i}$$

of the user corresponding to each time window. Through this step, an interest category that fully reflects the situation of the target user can be obtained. Among them, the fusion processing module 907 can use concatenation. In a specific implementation, by jointly inputting the high-level interest feature representations

$${P}_{z}^{1} … {P}_{z ″}^{L}$$

and the target interest category feature representations “C¹ . . . C^{L}” from different time windows into the fusion processing module 907 for processing, the target interest category feature representation of the target user output by the module 907 is obtained. The above target interest category feature representation can reflect the interest features of the target user. That is, the above target interest category feature representation can serve as the attribute feature of the target user's own interest, reflecting the user's hobbies.

Step S807, estimating a behavior probability of the target user towards a target behavior object using the target interest category representation of the target user.

This step estimates the behavior probability of the target user towards the target behavior object based on the target interest category feature representation obtained in the previous steps. Since the target interest category feature representation of the target user is the interest category to which the target user belongs, the data of other users in this interest category can be used to estimate the behavior of the target user, which is equivalent to making full use of all the collected data, without being limited by the target user's insufficient historical behavior data.

The specific implementation method of this step can be achieved by the following steps. It should be noted that the following method is only one of the ways, and there are obviously other implementation methods under the existing technology:

Step S807-1, performing an attention mechanism processing on the target interest category representation of the target user and a target behavior object feature representation to obtain an attention mechanism representation of the target user.

In this step, the target behavior object is the behavior object for which it is necessary to evaluate whether the target user is likely to click on it or perform other effective operations, for example, a certain product. Through this evaluation, the behavior object with a high probability of operation can be used as the actual display object. As shown in FIG. 9, the target behavior object 902 input to the HIM model is specifically a target behavior object feature representation.

The attention mechanism representation of the target user is obtained by processing the target interest category representation of the target user and the target behavior object feature representation, which obtains the association between the target interest category to which the target user belongs and the target behavior object.

The attention mechanism processing can be implemented by the attention mechanism processing module 908 (Attention) in FIG. 9.

Step S807-2, providing the attention mechanism representation of the target user and the target behavior object feature representation to a pre-trained machine learning model to obtain the behavior probability of the target user towards the target behavior object.

Since the attention mechanism representation of the target user obtained in the previous step has already expressed the association relationship between the target behavior object and the target interest category of the target user, this step uses the attention mechanism representation of the target user to calculate the probability of an effective operation occurring with the target behavior object. This step can be implemented in various ways, typically by using a Multiple Hidden Layer; for example, using the multiple hidden layer 909 in FIG. 9. Since the output value range of this multiple hidden layer 909 is large, a normalization step can be further added, that is, the normalization module 910 in FIG. 9 is used to normalize the output result, normalizing the output probability value to a range of 0 to 1.

This embodiment includes the UBP model for implementing the method of the first embodiment, and the UBC model for implementing the method of the second embodiment. Based on the above two models, a user behavior object prediction model (Hierarchical Interest Modeling, HIM) is implemented. This model extracts the user's interest features based on the user's historical data, clusters them into appropriate interest categories, and through these interest categories, estimates the probability of the target user operating the target behavior object (e.g., a product on an e-commerce platform) in an effective way. Since it adopts interest category clustering for the target user and then estimates their behavior probability based on the interest category they belong to, this method can better solve the problem of how to predict the behavior of long-tail users with insufficient data.

The first to third embodiments, although all are methods, can also be described as models. It can be considered that the methods are implemented by the corresponding models, and the models are used to implement the corresponding methods. They are two sides of the same item, just different expressions.

The basic processing of the HIM model and the method provided in the third embodiment can also be referred to in FIG. 10, which briefly describes the transformation between feature vectors in the HIM model. As shown in FIG. 10, the user behavior sample obtained in a certain time window can be represented by the symbol “x”. The above models can analyze and process the user behavior sample “x” to obtain the behavior object feature vector “χⁱ” for representing the user's behavior objects, and the behavior feature vector “\hat{x}ⁱ”. The above behavior object feature vector “χⁱ” includes a positive feedback object feature vector and a negative feedback object feature vector. This positive feedback object feature vector and negative feedback object feature vector are processed by the UBP model to obtain the user's preliminary interest feature representation

$${ubP}_{x ″}^{i} ,$$

In FIG. 10, it is abstractly represented as

$${P}_{x ″}^{i} .$$

where the coefficient “ub” can be understood as the weight parameter of this feature representation. Certainly, the preliminary interest feature representation

$${ubP}_{x ″}^{i}$$

can also be obtained through the user's behavior feature vector “\hat{x}ⁱ”, but since this process is not the research focus of this embodiment, it will not be described in detail.

The preliminary interest feature representation

$${ubP}_{x ″}^{i}$$

output by the UBP model can be input into the second transformer neural network 905 and the UBC model for processing, respectively. The preliminary interest feature representation

$${ubP}_{x ″}^{i}$$

is input into the second transformer neural network 905 to obtain the high-level interest feature representation

$${ubP}_{z ″}^{i}$$

output by the neural network, where the coefficient “ub” can also be understood as the weight parameter of this feature representation. The preliminary interest feature representation

$${ubP}_{x ″}^{i}$$

is input into the UBC model for encoding and mapping fusion processing to obtain the low-dimensional interest feature representation encoding [symbol] of the target user. Then, the interest feature representation encoding [symbol] is decoded to obtain the decoded interest feature representation encoding “ubθⁱ”. The high-level interest feature representation

$${ubP}_{z ″}^{i}$$

output by the second transformer neural network 905 is used as the direction for clustering learning. A self-supervised/semi-supervised learning process is constructed to enhance the robustness of the end-to-end clustering process, minimizing the distance between the decoded interest feature representation encoding “ubθⁱ” reconstructed and output by the decoder and the high-level interest feature representation

$${ubP}_{x ″}^{i} ,$$

and maximizing the similarity between the two. Through the above process, the transformation between feature vectors in the HIM model is realized.

The HIM model, as well as the UBP model and UBC model it contains, all need to be implemented through a large amount of training. The following fourth embodiment provides a method for training the HIM model.

### Fourth Embodiment

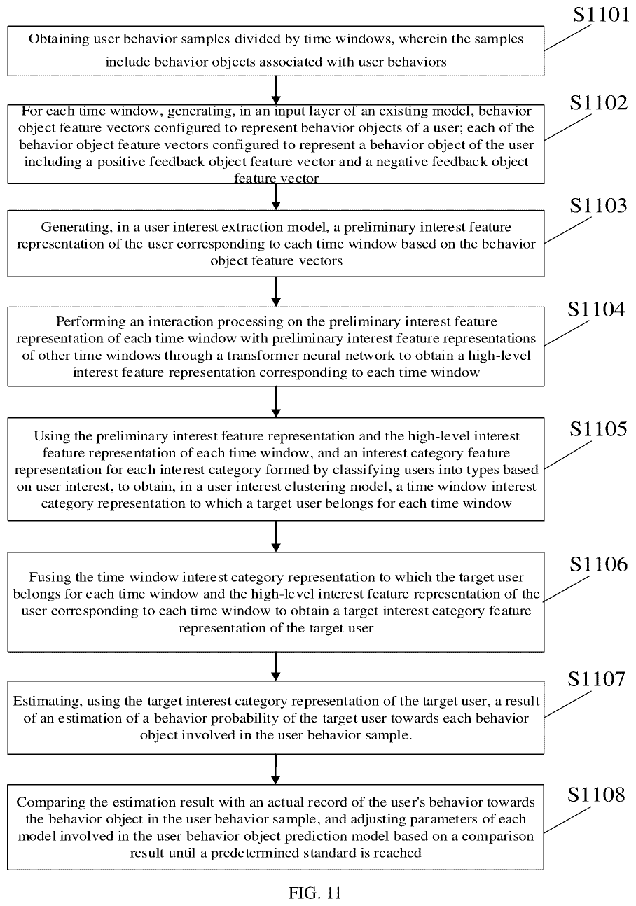

The fourth embodiment of the present application provides a method for training a user behavior object prediction model (i.e., the HIM model). Please refer to FIG. 11, and at the same time, in conjunction with FIG. 9 and FIG. 10. FIG. 11 is a flowchart of the method for training the user behavior object prediction model in the fourth embodiment of the present application. It should be noted that the training method provided in this embodiment also involves the model principle of the HIM model, that is, the user behavior object prediction method, so reference can be made to the specific description of the third embodiment of the present application. Certainly, for the specific training details of the UBP model and the UBC model involved in the above model training process, reference can also be made to the descriptions of the first and second embodiments of the present application, which will not be repeated in this embodiment.

Furthermore, for the training method of the user behavior object prediction model of the HIM model, by comparing the estimation result of the behavior probability of the behavior object with the actual record, the adjustment of the relevant parameters in the model is completed, which can realize end-to-end model

Step S1101, obtaining user behavior samples divided by time windows, wherein the samples include behavior objects associated with user behaviors.

Step S1102, for each time window, generating, in an input layer of an existing model, behavior object feature vectors configured to represent behavior objects of a user; each of the behavior object feature vector configured to represent a behavior object of the user including a positive feedback object feature vector and a negative feedback object feature vector.

Step S1103, generating, in a user interest extraction model, a preliminary interest feature representation of the user corresponding to each time window based on the behavior object feature vectors.

Step S1104, performing an interaction processing on the preliminary interest feature representation of each time window with preliminary interest feature representations of other time windows through a transformer neural network to obtain a high-level interest feature representation corresponding to each time window.

Step S1105, using the preliminary interest feature representation and the high-level interest feature representation of each time window, and an interest category feature representation for each interest category formed by classifying users into types based on user interest, to obtain, in a user interest clustering model, a time window interest category representation to which a target user belongs for each time window.

Step S1106, fusing the time window interest category representation to which the target user belongs for each time window and the high-level interest feature representation of the user corresponding to each time window to obtain a target interest category feature representation of the target user.

Step S1107, estimating, using the target interest category representation of the target user, a result of an estimation of a behavior probability of the target user towards each behavior object involved in the user behavior sample.

Step S1108, comparing the estimation result with an actual record of the user's behavior towards the behavior object in the user behavior sample, and adjusting parameters of each model involved in the user behavior object prediction model based on a comparison result until a predetermined standard is reached.

This embodiment is basically similar to the third embodiment. As a training method, it uses the behavior objects involved in the user behavior sample (which can be positive sample behavior objects or negative sample behavior objects) as the target behavior objects, compares the estimation result of the HIM model with the behavior objects actually operated by the user, and performs loss calculation based on the comparison result, and adjusts the various parameters in the HIM model based on the loss result.

In addition, the UBP model and the UBC model can also be trained and adjusted separately.

### Fifth Embodiment

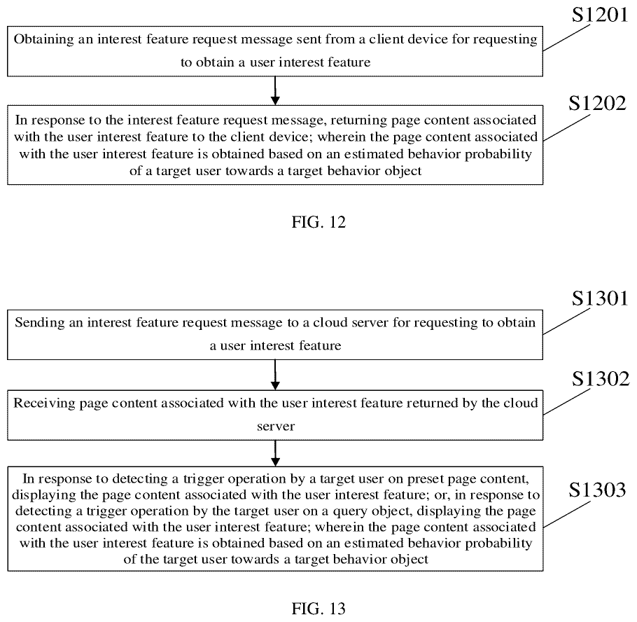

The fifth embodiment of the present application provides another method for generating a user interest feature, applied to a cloud server. Please refer to the illustration in FIG. 12, which is a flowchart of the method for generating a user interest feature in the fifth embodiment of the present application. It should be noted that this embodiment also involves the model principle of the HIM model, that is, the user behavior object prediction method, so reference can be made to the specific description of the third embodiment of the present application. Certainly, reference can also be made to the descriptions of the first and second embodiments of the present application.

Step S1201, obtaining an interest feature request message sent from a client device for requesting to obtain a user interest feature; it should be understood that the interest feature request message is a request message sent from the client device of the target user, and the interest feature request message is used to obtain page content associated with the user interest feature of the target user.

Step S1202, in response to the interest feature request message, returning page content associated with the user interest feature to the client device; wherein the page content associated with the user interest feature is obtained based on an estimated behavior probability of a target user towards a target behavior object;
the estimated behavior probability of the target user towards the target behavior object is obtained as follows:
obtaining a user behavior sample divided by time windows; generating a behavior object feature vector configured to represent a behavior object of a user based on the user behavior sample; the behavior object feature vector configured to represent the behavior object of the user including a positive feedback object feature vector and a negative feedback object feature vector; generating a preliminary interest feature representation of the user corresponding to each time window based on the behavior object feature vector; performing an interaction processing on the preliminary interest feature representation of each time window with preliminary interest feature representations of other time windows to obtain a high-level interest feature representation for each time window; using the preliminary interest feature representation and the high-level interest feature representation of each time window, and an interest category feature representation for each interest category formed by classifying users into types based on user interest, to obtain a time window interest category representation to which the target user belongs for each time window; fusing the time window interest category representation to which the target user belongs for each time window and the high-level interest feature representation of the user corresponding to each time window to obtain a target interest category feature representation of the target user; and estimating the behavior probability of the target user towards the target behavior object using the target interest category representation of the target user.

In this embodiment, on the cloud server, the process of obtaining the page content associated with the user interest feature in response to the interest feature request message can be referred to in the description of the user behavior object prediction method embodiment of the third embodiment of the present application. In a specific implementation, based on the estimated behavior probability of the target user towards the target behavior object, the target behavior object is filtered by a conditional threshold, and the target behavior object whose estimated behavior probability meets the conditional threshold is used as the page content associated with the user interest feature, for exposure and display to the target user on the client device.

### Sixth Embodiment

The sixth embodiment of the present application provides another method for generating a user interest feature, applied to a client device. Please refer to the illustration in FIG. 13, which is a flowchart of the method for generating a user interest feature in the sixth embodiment of the present application. It should be noted that this embodiment also involves the model principle of the HIM model, that is, the user behavior object prediction method, so reference can be made to the specific description of the third embodiment of the present application. Of course, reference can also be made to the descriptions of the first and second embodiments of the present application.
Step S1301, sending an interest feature request message to a cloud server for requesting to obtain a user interest feature;
Step S1302, receiving page content associated with the user interest feature returned by the cloud server;
Step S1303, in response to detecting a trigger operation by a target user on preset page content, displaying the page content associated with the user interest feature; or, in response to detecting a trigger operation by the target user on a query object, displaying the page content associated with the user interest feature;
wherein the page content associated with the user interest feature is obtained based on an estimated behavior probability of the target user towards a target behavior object, which is estimated by the cloud server according to the method provided in the fifth embodiment.

It should be understood that in the embodiments of the present application, the preset page content is the content that is exposed and displayed to the target user when the target user initially enters the application. The above preset page content is randomly initialized content and has a low degree of association with the target user's user interest features. Therefore, in this embodiment, based on the target user's trigger operation on the preset page content, such as a click operation or browsing operation on the products on the initial page, the client device of the target user obtains and displays the page content associated with the target user's user interest features. Alternatively, based on the target user's trigger operation on a query object, for example, a search operation for a certain product in the page content, the page content associated with the target user's user interest features related to the search content can be obtained. For the above page content associated with the target user's user interest features, reference can be made to the descriptions of the third and fifth embodiments of the present application, which will not be repeated here.

### Seventh Embodiment

The first embodiment provides a method for generating a user interest feature. Correspondingly, the seventh embodiment of the present application also provides an apparatus for generating a user interest feature. Since the apparatus embodiment is basically similar to the method embodiment, the description is relatively simple. For details of the relevant technical features and implementation effects, please refer to the corresponding description of the method embodiment provided above. The following description of the apparatus embodiment is merely illustrative.

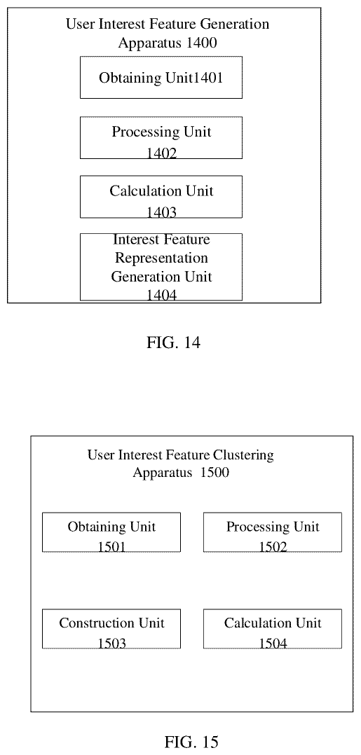

Please refer to FIG. 14 to understand this embodiment. FIG. 14 is a block diagram of the apparatus for generating a user interest feature provided in this embodiment. As shown in FIG. 4, the user interest feature generation apparatus 1400 provided in this embodiment includes:
an obtaining unit 1401, configured to obtain behavior object feature vectors corresponding to a target time window and configured to represent behavior objects of a user; each of the behavior object feature vector configured to represent a behavior object of the user including a positive feedback object feature vector and a negative feedback object feature vector;
a processing unit 1402, configured to perform an aggregation calculation on the negative feedback object feature vectors to obtain an aggregated negative feedback object vector corresponding to the negative feedback object feature vectors;
a calculation unit 1403, configured to calculate a correlation between the aggregated negative feedback object vector and each of the positive feedback object feature vectors;
an interest feature representation generation unit 1404, configured to generate a preliminary interest feature representation of the user corresponding to the target time window based on the correlation, the positive feedback object feature vectors, and the aggregated negative feedback object vector.

### Eighth Embodiment

The second embodiment provides a method for user interest feature clustering. Correspondingly, the eighth embodiment of the present application also provides an apparatus for user interest feature clustering. Since the apparatus embodiment is basically similar to the method embodiment, the description is relatively simple. For details of the relevant technical features and implementation effects, please refer to the corresponding description of the method embodiment provided above. The following description of the apparatus embodiment is merely illustrative.

Please refer to FIG. 15 to understand this embodiment. FIG. 15 is a block diagram of the apparatus for user interest feature clustering provided in this embodiment. As shown in FIG. 15, the user interest feature clustering apparatus 1500 provided in this embodiment includes:
an obtaining unit 1501, configured to obtain a preliminary interest feature representation and an interest category feature representation of a target user; the interest category feature representation being a feature representation for each interest category formed by classifying users into types based on user interest;
a processing unit 1502, configured to perform a mapping and fusion process on the preliminary interest feature representation of the target user based on the interest category feature representation to obtain an interest feature representation encoding of the target user;
a construction unit 1503, configured to perform a decoding processing on the interest feature representation encoding of the target user to obtain a decoded interest feature representation encoding;
a calculation unit 1504, configured to calculate a loss value between the decoded interest feature representation encoding and a preset target interest feature representation, and adjust the encoder model, the decoder model, and the interest category feature representation based on the loss value until the loss value reaches a predetermined target; and obtain an interest category representation to which the target user belongs in the target time window based on a dimension-reduced feature representation at this time.

### Ninth Embodiment

The third embodiment provides a user behavior object prediction method. Correspondingly, the ninth embodiment of the present application also provides a user behavior object prediction apparatus. Since the apparatus embodiment is basically similar to the method embodiment, the description is relatively simple. For details of the relevant technical features and implementation effects, please refer to the corresponding description of the method embodiment provided above. The following description of the apparatus embodiment is merely illustrative.

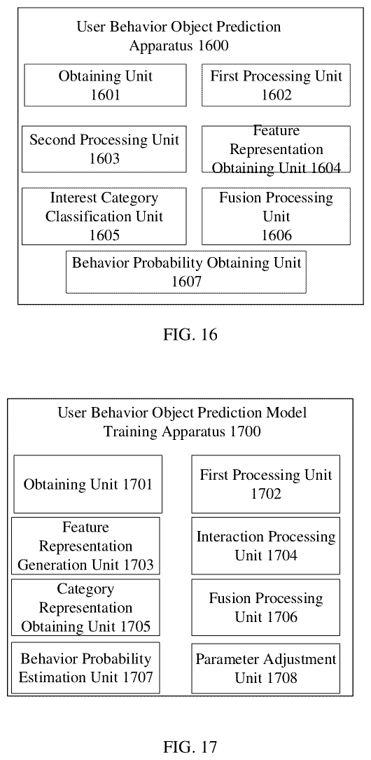

Please refer to FIG. 16 to understand this embodiment. FIG. 16 is a block diagram of the user behavior object prediction apparatus provided in this embodiment. As shown in FIG. 16, the user behavior object prediction apparatus 1600 provided in this embodiment includes:
an obtaining unit 1601, configured to obtain a user behavior sample divided by time windows;
a first processing unit 1602, configured to generate behavior object feature vectors configured to represent behavior objects of a user based on the user behavior sample; each of the behavior object feature vectors configured to represent a behavior object of the user including a positive feedback object feature vector and a negative feedback object feature vector;
a second processing unit 1603, configured to generate a preliminary interest feature representation of the user corresponding to each time window based on the behavior object feature vectors;
a feature representation obtaining unit 1604, configured to perform an interaction processing on the preliminary interest feature representation of each time window with preliminary interest feature representations of other time windows to obtain a high-level interest feature representation for each time window;
an interest category classification unit 1605, configured to use the preliminary interest feature representation and the high-level interest feature representation of each time window, and an interest category feature representation for each interest category formed by classifying users into types based on user interest, to obtain a time window interest category representation to which a target user belongs for each time window;
a fusion processing unit 1606, configured to fuse the time window interest category representation to which the target user belongs for each time window and the high-level interest feature representation of the user corresponding to each time window to obtain a target interest category feature representation of the target user;
a behavior probability obtaining unit 1607, configured to estimate a behavior probability of the target user towards a target behavior object using the target interest category representation of the target user.

### Tenth Embodiment

The fourth embodiment provides a method for training a user behavior object prediction model. Correspondingly, the tenth embodiment of the present application also provides a user behavior object prediction model training apparatus. Since the apparatus embodiment is basically similar to the method embodiment, the description is relatively simple. For details of the relevant technical features and implementation effects, please refer to the corresponding description of the method embodiment provided above. The following description of the apparatus embodiment is merely illustrative.

Please refer to FIG. 17 to understand this embodiment. FIG. 17 is a block diagram of the user behavior object prediction model training apparatus provided in this embodiment. As shown in FIG. 17, the user behavior object prediction model training apparatus 1700 provided in this embodiment includes:
an obtaining unit 1701, configured to obtain user behavior sample divided by time windows, wherein the samples include behavior objects associated with user behaviors;
a first processing unit 1702, configured to, for each time window, generate, in an input layer of an existing model, behavior object feature vectors configured to represent behavior objects of a user; each of the behavior object feature vectors configured to represent a behavior object of the user including a positive feedback object feature vector and a negative feedback object feature vector;
a feature representation generation unit 1703, configured to generate, in a user interest extraction model, a preliminary interest feature representation of the user corresponding to each time window based on the behavior object feature vectors;
an interaction processing unit 1704, configured to perform an interaction processing on the preliminary interest feature representation of each time window with preliminary interest feature representations of other time windows through a transformer neural network to obtain a high-level interest feature representation corresponding to each time window;
a category representation obtaining unit 1705, configured to use the preliminary interest feature representation and the high-level interest feature representation of each time window, and an interest category feature representation for each interest category formed by classifying users into types based on user interest, to obtain, in a user interest clustering model, a time window interest category representation to which a target user belongs for each time window;
a fusion processing unit 1706, configured to fuse the time window interest category representation to which the target user belongs for each time window and the high-level interest feature representation of the user corresponding to each time window to obtain a target interest category feature representation of the target user;
a behavior probability estimation unit 1707, configured to estimate, using the target interest category representation of the target user, a result of an estimation of a behavior probability of the target user towards each behavior object involved in the user behavior sample;
a parameter adjustment unit 1708, configured to compare the estimation result with an actual record of the user's behavior towards the behavior object in the user behavior sample, and adjust parameters of each model involved in the user behavior object prediction model based on a comparison result until a predetermined standard is reached.

### Eleventh Embodiment

The fifth embodiment provides a method for generating a user interest feature. Correspondingly, the eleventh embodiment of the present application also provides an apparatus for generating a user interest feature, applied to a cloud server. Since the apparatus embodiment is basically similar to the method embodiment, the description is relatively simple. For details of the relevant technical features and implementation effects, please refer to the corresponding description of the method embodiment provided above. The following description of the apparatus embodiment is merely illustrative.

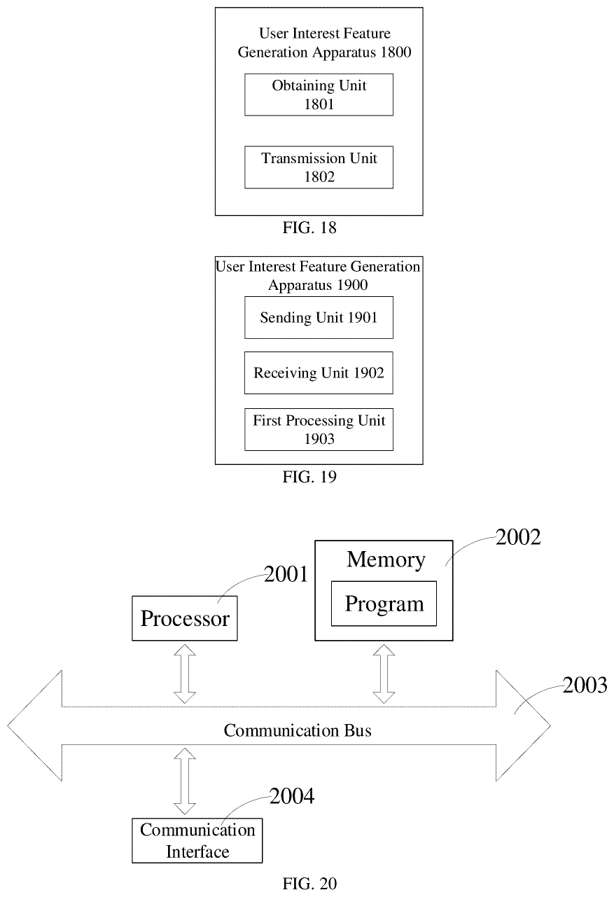

Please refer to FIG. 18 to understand this embodiment. FIG. 18 is a block diagram of the apparatus for generating a user interest feature provided in this embodiment. As shown in FIG. 18, the user interest feature generation apparatus 1800 provided in this embodiment includes:
an obtaining unit 1804, configured to obtain an interest feature request message sent from a client device for requesting to obtain a user interest feature;
a transmission unit 1802, configured to, in response to the interest feature request message, return page content associated with the user interest feature to the client device; wherein the page content associated with the user interest feature is obtained based on an estimated behavior probability of a target user towards a target behavior object;
the estimated behavior probability of the target user towards the target behavior object is obtained as follows:
obtaining a user behavior sample divided by time windows; generating behavior object feature vectors configured to represent behavior objects of a user based on the user behavior samples; each of the behavior object feature vectors configured to represent a behavior object of the user including a positive feedback object feature vector and a negative feedback object feature vector; generating a preliminary interest feature representation of the user corresponding to each time window based on the behavior object feature vectors; performing an interaction processing on the preliminary interest feature representation of each time window with preliminary interest feature representations of other time windows to obtain a high-level interest feature representation for each time window; using the preliminary interest feature representation and the high-level interest feature representation of each time window, and an interest category feature representation for each interest category formed by classifying users into types based on user interest, to obtain a time window interest category representation to which the target user belongs for each time window; fusing the time window interest category representation to which the target user belongs for each time window and the high-level interest feature representation of the user corresponding to each time window to obtain a target interest category feature representation of the target user; and estimating the behavior probability of the target user towards the target behavior object using the target interest category representation of the target user.

### Twelfth Embodiment

The sixth embodiment provides a method for generating a user interest feature. Correspondingly, the twelfth embodiment of the present application also provides an apparatus for generating a user interest feature, applied to a client device. Since the apparatus embodiment is basically similar to the method embodiment, the description is relatively simple. For details of the relevant technical features and implementation effects, please refer to the corresponding description of the method embodiment provided above. The following description of the apparatus embodiment is merely illustrative.

Please refer to FIG. 19 to understand this embodiment. FIG. 19 is a block diagram of the apparatus for generating a user interest feature provided in this embodiment. As shown in FIG. 19, the user interest feature generation apparatus 1900 provided in this embodiment includes:
a sending unit 1901, configured to send an interest feature request message to a cloud server for requesting to obtain a user interest feature;
a receiving unit 1902, configured to receive page content associated with the user interest feature returned by the cloud server;
a first processing unit 1903, configured to, in response to detecting a trigger operation by a target user on preset page content, display the page content associated with the user interest feature; or, in response to detecting a trigger operation by the target user on a query object, display the page content associated with the user interest feature;
wherein the page content associated with the user interest feature is obtained based on an estimated behavior probability of the target user towards a target behavior object, which is estimated by the apparatus provided in the eleventh embodiment.

### Thirteenth Embodiment

In the above embodiments, various methods and their corresponding apparatuses are provided. In addition, the embodiments of the present application also provide an electronic device embodiment corresponding to the above method embodiments and apparatus embodiments. Since the electronic device embodiment is basically similar to the method embodiment, the description is relatively simple. For details of the relevant technical features and implementation effects, please refer to the corresponding description of the method embodiment provided above. The following description of the electronic device embodiment is merely illustrative. The electronic device embodiment is as follows:

Please refer to FIG. 20 to understand the above electronic device. FIG. 20 is a schematic diagram of the electronic device. The electronic device provided in this embodiment includes: a processor 2001, a memory 2002, a communication bus 2003, and a communication interface 2004.

The processor 2001 is used to execute computer software instructions. The computer software designed according to the methods provided in the foregoing embodiments is stored in the memory 2002. When the instructions in the memory 2002 are loaded into the processor 2001, these instructions are executed to implement the steps of the various method embodiments described above. The communication bus 2003 is used to connect the processor 2001 and the memory 2002 mounted on it. The communication interface 2004 is used to provide a connection interface for the processor 2001 and the memory 2002.

### Fourteenth Embodiment

In the above embodiments, various methods and their corresponding apparatuses are provided. In addition, the embodiments of the present application also provide a computer-readable storage medium for implementing the above methods. The description of the computer-readable storage medium embodiment provided in the present application is relatively simple. For relevant parts, please refer to the corresponding description of the method embodiment above. The following described embodiment is merely illustrative.

The computer-readable storage medium provided in this embodiment stores computer instructions, which, when executed by a processor, implement the steps shown in the above method embodiments, and will not be repeated here.

In a typical configuration, a computing device includes one or more processors (CPUs), input/output interfaces, network interfaces, and memory.

Memory may include forms of non-persistent storage, random access memory (RAM), and/or non-volatile memory in computer-readable media, such as read-only memory (ROM) or flash memory (flash RAM). Memory is an example of a computer-readable medium.

1. Computer-readable media include permanent and non-permanent, removable and non-removable media, which can be used to store information by any method or technology. The information can be computer-readable instructions, data structures, program modules, or other data. Examples of computer storage media include, but are not limited to, phase-change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic cassettes, magnetic tape, magnetic disk storage or other magnetic storage devices, or any other non-transitory medium that can be used to store information that can be accessed by a computing device. As defined herein, computer-readable media do not include non-transitory computer-readable media (transitory media), such as modulated data signals and carriers.

2. A person skilled in the art should understand that the embodiments of the present application can be provided as a method, system, or computer program product. Therefore, the present application can take the form of a completely hardware embodiment, a completely software embodiment, or an embodiment combining software and hardware aspects. Moreover, the present application can take the form of a computer program product implemented on one or more computer-usable storage media (including but not limited to disk storage, CD-ROM, optical storage, etc.) containing computer-usable program code.

Although the present invention has been disclosed above with preferred embodiments, it is not intended to limit the present invention. Any person skilled in the art can make possible changes and modifications without departing from the spirit and scope of the present invention. Therefore, the protection scope of the present invention should be determined by the scope defined by the claims of the present invention.

It should be noted that the embodiments of the present application may involve the use of user data. In practical applications, user-specific personal data may be used in the solutions described herein within the scope permitted by applicable laws and regulations (e.g., with explicit user consent, effective notification to the user, etc.) and in compliance with the requirements of the applicable laws and regulations of the country where it is located. It should be noted that the embodiments of the present application may involve the use of user data. In practical applications, user-specific personal data may be used in the solutions described herein within the scope permitted by applicable laws and regulations (e.g., with explicit user consent, effective notification to the user, etc.) and in compliance with the requirements of the applicable laws and regulations of the country where it is located.

What is claimed is:

1. A method for generating a user interest feature, comprising:
obtaining behavior object feature vectors corresponding to a target time window and configured to represent behavior objects of a user, wherein each of the behavior object feature vector configured to represent a behavior object of the user comprises a positive feedback object feature vector and a negative feedback object feature vector;
performing an aggregation calculation on the negative feedback object feature vectors to obtain an aggregated negative feedback object vector corresponding to the negative feedback object feature vectors;
calculating a correlation between the aggregated negative feedback object vector and each of the positive feedback object feature vectors; and
generating a preliminary interest feature representation of the user corresponding to the target time window based on the correlation, the positive feedback object feature vectors, and the aggregated negative feedback object vector.

2. The method of claim 1, wherein obtaining the behavior object feature vectors corresponding to the target time window and configured to represent the behavior objects of the user comprises:
obtaining a user behavior sequence sample;
performing a grouping process on the user behavior sequence sample corresponding to a preset time window to obtain a user behavior group sample corresponding to each time window;
for each of the user behavior group samples, obtaining behavior objects corresponding to user behaviors therein; and
within a selected target time window, generating the behavior object feature vectors corresponding to the target time window based on the behavior objects corresponding to the user behaviors.

3. The method of claim 2, wherein generating the behavior object feature vectors corresponding to the target time window based on the behavior objects corresponding to the user behaviors within the selected target time window comprises:
filtering the behavior objects of the user in the selected target time window according to a preset filtering condition to obtain sample behavior objects; and
generating the behavior object feature vectors corresponding to the target time window based on the sample behavior objects.

4. The method of claim 3, wherein the preset filtering condition comprises one or more of the following factors: a frequency of the user's behavior towards a behavior object reaches a preset value, a time duration of the user's behavior towards a behavior object reaches a preset value, or a type of the user's behavior towards a behavior object conforms to a preset type.

5. The method of claim 1, wherein generating the preliminary interest feature representation of the user corresponding to the target time window based on the correlation, the positive feedback object feature vectors, and the aggregated negative feedback object vector comprises:
obtaining a correlation index of each of the positive feedback object feature vectors with the aggregated negative feedback object vector;
using the positive feedback object feature vectors whose correlation index is lower than a preset correlation threshold as available positive feedback object feature vectors; and
generating the preliminary interest feature representation of the user based on the correlation, the available positive feedback object feature vectors, and the aggregated negative feedback object vector.

6. The method of claim 5, wherein generating the preliminary interest feature representation of the user based on the correlation, the available positive feedback object feature vectors, and the aggregated negative feedback object vector comprises:
assigning a second weight to each of the available positive feedback object feature vectors in a preset manner based on the correlation of the available positive feedback object feature vectors with the aggregated negative feedback object vector, wherein the higher the correlation, the lower the weight; and
generating the preliminary interest feature representation of the user using the aggregated negative feedback object vector and the weighted positive feedback object feature vectors.

7. The method of claim 6, wherein generating the preliminary interest feature representation of the user using the aggregated negative feedback object vector and the weighted positive feedback object feature vectors comprises:
inputting each of the weighted positive feedback object feature vectors into a first transformer neural network to obtain an aggregated positive feedback object vector; and
fusing the aggregated positive feedback object vector and the aggregated negative feedback object vector to obtain the preliminary interest feature representation of the user.

8. The method of claim 1, wherein before the step of generating the preliminary interest feature representation of the user corresponding to the target time window based on the correlation, the positive feedback object feature vectors, and the aggregated negative feedback object vector, the method further comprises:
assigning a first weight to a corresponding positive feedback object feature vector based on a frequency of each of the positive feedback objects as a user behavior object;
wherein in the step of generating the preliminary interest feature representation of the user corresponding to the target time window based on the correlation, the positive feedback object feature vectors, and the aggregated negative feedback object vector, the positive feedback object feature vectors assigned with the first weight are used.

9. The method of claim 1, wherein fusing the aggregated positive feedback object vector and the aggregated negative feedback object vector is performed by concatenation.

10. A non-transitory computer-readable storage medium configured with instructions executable by one or more processors to cause the one or more processors to perform the method of claim 1.

11. An electronic device comprising:
one or more processors; and
one or more computer-readable memories coupled to the one or more processors and having instructions stored thereon that are executable by the one or more processors to perform the method of claim 1.

12. A method for user interest feature clustering, the method comprising:
obtaining a preliminary interest feature representation and an interest category feature representation of a target user, wherein the interest category feature representation is a feature representation for each interest category formed by classifying users into types based on user interest;
performing a mapping and fusion process on the preliminary interest feature representation of the target user based on the interest category feature representation to obtain an interest feature representation encoding of the target user;
performing a decoding process on the interest feature representation encoding of the target user to obtain a decoded interest feature representation encoding; and
calculating a loss value between the decoded interest feature representation encoding and a preset target interest feature representation, and adjusting an encoder model, a decoder model, and the interest category feature representation based on the loss value until the loss value reaches a predetermined target; and obtaining an interest category representation to which the target user belongs in the target time window based on a dimension-reduced feature representation at this time.

13. The method of claim 12, wherein the target interest feature representation uses the preliminary interest feature representation of the user, or uses a high-level interest feature representation; wherein the high-level interest feature representation is obtained after performing an association process on the preliminary interest feature representation of the target time window and preliminary interest feature representations of other time windows.

14. A non-transitory computer-readable storage medium configured with instructions executable by one or more processors to cause the one or more processors to perform the method of claim 12.

15. An electronic device comprising:
one or more processors; and
one or more computer-readable memories coupled to the one or more processors and having instructions stored thereon that are executable by the one or more processors to perform the method of claim 12.

16. A user behavior object prediction method, comprising:
obtaining user behavior samples divided by time windows;
generating behavior object feature vectors configured to represent behavior objects of a user based on the user behavior samples, wherein each of the behavior object feature vectors configured to represent a behavior object of the user comprises a positive feedback object feature vector and a negative feedback object feature vector;
generating a preliminary interest feature representation of the user corresponding to each time window based on the behavior object feature vectors;
performing an interaction process on the preliminary interest feature representation of each time window with preliminary interest feature representations of other time windows to obtain a high-level interest feature representation for each time window;
using the preliminary interest feature representation and the high-level interest feature representation of each time window, and an interest category feature representation for each interest category formed by classifying users into types based on user interest, to obtain a time window interest category representation to which a target user belongs for each time window;
fusing the time window interest category representation to which the target user belongs for each time window and the high-level interest feature representation of the user corresponding to each time window to obtain a target interest category feature representation of the target user; and
estimating a behavior probability of the target user towards a target behavior object using the target interest category representation of the target user.

17. The method of claim 16, wherein, within generating the preliminary interest feature representation of the user corresponding to each time window based on the behavior object feature vectors, a process of generating the preliminary interest feature representation corresponding to a target time window comprises:
obtaining behavior object feature vectors corresponding to the target time window and configured to represent behavior objects of the user, wherein each of the behavior object feature vectors configured to represent a behavior object of the user comprises a positive feedback object feature vector and a negative feedback object feature vector;
performing an aggregation calculation on the negative feedback object feature vectors to obtain an aggregated negative feedback object vector corresponding to the negative feedback object feature vectors;
calculating a correlation between the aggregated negative feedback object vector and each of the positive feedback object feature vectors; and
generating the preliminary interest feature representation of the user corresponding to the target time window based on the correlation, the positive feedback object feature vectors, and the aggregated negative feedback object vector.

18. The method of claim 16, wherein using the preliminary interest feature representation and the high-level interest feature representation of each time window, and the interest category feature representation for each interest category formed by classifying users into types based on user interest, to obtain the time window interest category representation to which the target user belongs for each time window, comprises:
obtaining a preliminary interest feature representation and an interest category feature representation of the target user in a target time window;
performing a mapping and fusion process on the preliminary interest feature representation of the target user based on the interest category feature representation to obtain an interest feature representation encoding of the target user;
performing a decoding process on the interest feature representation encoding of the target user to obtain a decoded interest feature representation encoding; and
calculating a loss value between the decoded interest feature representation encoding and the high-level interest feature representation of the user in the target time window, and adjusting an encoder model, a decoder model, and the interest category feature representation based on the loss value until the loss value reaches a predetermined target; and obtaining the interest category representation to which the target user belongs in the target time window based on a dimension-reduced feature representation at this time.

19. The method of claim 16, wherein estimating the behavior probability of the target user towards the target behavior object using the target interest category representation of the target user comprises:
performing an attention mechanism process on the target interest category representation of the target user and a target behavior object feature representation to obtain an attention mechanism representation of the target user; and
providing the attention mechanism representation of the target user and the target behavior object feature representation to a pre-trained machine learning model to obtain the behavior probability of the target user towards the target behavior object.

20. An electronic device comprising:
one or more processors; and
one or more computer-readable memories coupled to the one or more processors and having instructions stored thereon that are executable by the one or more processors to perform the method of claim 16.
